(19) United States
(12) Patent Application Publication
(10) Pub. No.: US 2020/0079192 A1
(43) Pub. Date: Mar. 12, 2020

(54) MODULAR HALF DOOR

(71) Applicant: Bestop, Inc., Louisville, CO (US)

(72) Inventors: Eric D. Getzschman, New Baltimore, MI (US); George C. Stickles, Thornton, CO (US); William H. Haberkamp, Rochester Hills, MI (US)

(73) Assignee: Bestop, Inc., Louisville, CO (US)

(21) Appl. No.: 16/681,686

(22) Filed: Nov. 12, 2019

Related U.S. Application Data
(63) Continuation-in-part of application No. 16/173,881, filed on Oct. 29, 2018.
Application No. 16/173,881 is a continuation-in-part of application No. 15/915,960, filed on Mar. 8, 2018.
(60) Provisional application No. 62/468,666, filed on Mar. 8, 2017.
(60) Provisional application No. 62/640,317, filed on Mar. 8, 2018.
(60) Provisional application No. 62/750,625, filed on Oct. 25, 2018.
(60) Provisional application No. 62/759,937, filed on Nov. 12, 2018.

(51) Int. Cl. B60J 5/04

(52) U.S. Cl. CPC B60J 5/0476; B60J 5/0487; B60J 5/0469; B60J 5/0412

(57) ABSTRACT

A side door assembly is provided for a vehicle body having a side opening. The side door assembly includes a one-piece casting for hinged connection to the vehicle body. The casting forms a frame. At least one panel insert is selectively connected from the interior of the vehicle outward by a plurality of rotary attachment features to the frame. The frame includes a plurality of reinforcement features to add structure and rigidity, while reducing weight, to the side door assembly.

### CROSS-REFERENCE TO RELATED APPLICATIONS

This application is a Continuation-in-Part of U.S. patent application Ser. No. 16/173,881, filed Oct. 29, 2018, which is a Continuation-in-Part of U.S. patent application Ser. No. 15/915,960, filed Mar. 8, 2018, which claims benefit of 62/468,666, filed Mar. 8, 2017, and, U.S. patent application Ser. No. 16/173,881, filed Oct. 29, 2018 also claims benefit of U.S. Provisional Application No. 62/640,317, filed Mar. 8, 2018 and U.S. Provisional Application No. 62/750,625, filed Oct. 25, 2018. This application also claims the benefit of U.S. Provisional Application No. 62/759,937, filed Nov. 12, 2018. The disclosures of the above applications are incorporated herein by reference.

### FIELD OF THE INVENTION

The field of the present invention is that of side doors for automotive vehicles, more particularly, side doors for sport utility vehicles such as those manufactured by Jeep™ and that are customizable by the owner.

### BACKGROUND OF THE INVENTION

Many owners of sport utility vehicles, especially Jeeps, seek to enjoy their vehicles in the outdoors. To maximize the outdoor experience, many owners replace their original equipment side doors for other side doors that can be customized to enhance the driving experience. Often these doors allow the car operator to have greater exposure to the outdoor environment. It is desirable that these customizable doors be as rigid as possible to minimize squeaks and rattles while at the same time being as light as possible to maximize the joy of driving such a vehicle.

### SUMMARY OF THE INVENTION

To make manifest the above noted and other gainful desires, a revelation of the present invention is brought forth. The present inventions endows the freedom of a side door assembly for an automotive vehicle body having a side opening. The door assembly has a front casting for hinged connection with the vehicle body. Preferably the front casting will be die cast aluminum or titanium to minimize weight. A rear casting is also provided, allowing the door to be latched to the vehicle body. An extrusion or extrusions connect front and rear castings. An optional window frame can be added to further complete the door assembly.

In a preferred embodiment, the door assembly has a one-piece casting for hinged connection with the vehicle body. Preferably the front casting is die cast aluminum or titanium to minimize weight. Preferably, the one-piece casting provides a front door hinged to the vehicle body. A one-piece second casting is also provided, allowing the door to be latched to the vehicle body. Preferably the rear casting is die cast aluminum or titanium to minimize weight. Preferably, the one-piece second casting provides a rear door hinged to the vehicle body. An optional window frame can be added to the first and/or second one-piece casting further complete the door assemblies.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

FIG. 1 is a perspective view of a preferred embodiment side door assembly according to the present invention, shown installed in a Jeep-type vehicle;

FIG. 2 is a rear plan view of rear side door assembly shown in FIG. 1;

FIG. 3 is a rear plan view of the front side door assembly shown in FIG. 1;

FIG. 4 is a perspective view of the door assembly shown in FIG. 1 with an alternative hinge pin arrangement;

FIG. 5 is a view similar to that of FIG. 4, illustrating the side door assembly/assemblies shown in FIG. 4 having an additional door panel added thereon;

FIG. 6 is a perspective sectional view illustrating an inner seal utilized for sealing a lower portion of a door assembly according to the present invention;

FIG. 7 is a perspective sectional view of a rear casting of a door assembly according to the present invention illustrating a latch for connection of the door assembly to the vehicle;

FIG. 8 is a door assembly according to the present invention, having a singular lower extrusion connecting front and rear castings;

FIG. 9 is a perspective view of an alternate preferred embodiment side door assembly according to the present invention providing a quarter door;

FIG. 10A is a view of the door assembly according to the present invention providing a half door;

FIG. 10B is a perspective view of the door assembly according to the present invention providing a half door that is netted in a racecar manner;

FIG. 11 is a perspective view of an alternate preferred embodiment door assembly according to the present invention wherein the door extends outwardly;

FIG. 12 is a door assembly similar to that shown in FIG. 11 having an outer door panel;

FIG. 13A is a door assembly similar to that previously described in FIG. 10A having an outer panel;

FIG. 13B is a door similar to that shown in FIG. 13A, additionally having a window frame providing a full door;

FIG. 14 is an exploded view illustrating a method of connection of an extrusion to a casting of the door assembly according to the present invention;

FIG. 15 is an exploded view illustrating an alternate preferred method of connection of an extrusion to a casting of the door assembly according to the present invention;

FIG. 16 is an exploded view illustrating yet another alternate method of connection of extrusion to a casting of the door assembly according to the present invention;

FIG. 17 is a sectioned view illustrating the connection of a portion of the window frame to the remainder of the door assembly of the present invention;

FIG. 18 is a perspective view illustrating the connection of a portion of the window frame to a front of the door assembly casting of the present invention;

FIG. 19 is a perspective view of a window frame of FIG. 18 frame position on its side;

FIG. 20 is a perspective interior view illustrating the window frame of FIG. 18;

FIG. 21 is a side elevational view taken from the interior of the vehicle illustrating a door assembly with an installed outer panel;

FIG. 22 is an enlarged view of the side door assembly shown in FIG. 21 with most of the window frame being removed for clarity of illustration;

FIG. 23 is a perspective view of the door assembly shown in FIG. 22 from the outside of the vehicle;

FIG. 24 is an enlarged perspective view illustrating a portion of a rear casting and extrusion having a recess for acceptance of an outer door panel of FIG. 23;

FIG. 25 is an enlarged perspective view illustrating cam toggles attached to the back side of an outer door panel shown in FIG. 20;

FIG. 26 is a view showing greater detail of the window frame utilized in the door assembly of FIG. 21;

FIG. 27 is an exterior view of a portion of the door assembly illustrating the window frame of the door assembly shown in FIG. 26;

FIG. 28 is an exterior view perspective of an upper window frame casting of the window frame assembly shown in FIG. 26;

FIG. 29 is a sectioned view of the top extrusion frame shown in FIG. 27;

FIG. 30 is a sectioned view illustrating a portion of one of the upright extrusions of the door assembly of FIG. 27;

FIG. 31 is similar to that of FIG. 30 of the other upright extrusion of the window frame;

FIG. 32 is a section illustrating the soft goods attachment method of the window frame shown in FIG. 27;

FIG. 33 is an exploded view similar to that of FIG. 32 illustrating the means of attachment of the frame piece to the lower extrusion of the window frame of the door assembly according to the present inventions;

FIG. 34 is a view taken along line 34-34 of FIG. 3;

FIG. 35 is a view taken along line 35-34 of FIG. 3;

FIG. 36 is a perspective view of a bump-out door assembly of the present invention;

FIG. 37 is a perspective view of an alternate embodiment of a bump-out door assembly of the present invention;

FIG. 38 is a perspective view of a side door assembly taken from the outside of the vehicle shown installed in a sport utility vehicle, in accordance with the present invention;

FIG. 39 is a perspective view of the front side door assembly shown in FIG. 38 taken from the inside of the vehicle, and additionally having a window frame providing a full door, according to the present invention;

FIG. 40 is a perspective view of the front modular door of the side door assembly of FIG. 38 taken from outside of the vehicle, shown installed in a sport utility vehicle, according to the present invention;

FIG. 41 is a perspective view of the side door assembly of FIG. 38 shown installed in a sport utility vehicle, including an alternative panel that is transparent, in accordance with the present invention;

FIG. 42 is a perspective view of the front side door assembly of FIG. 38 taken from outside of the vehicle, shown installed in a sport utility vehicle, including an alternative embodiment with the panel removed, in accordance with the present invention;

FIG. 43 is a rear perspective view of the front side door assembly of FIG. 38 taken from interior of the vehicle;

FIG. 44 is a rear perspective view of the rear side door assembly of FIG. 38 taken from interior of the vehicle;

FIG. 45 is a perspective view of a side door assembly with an add-on accessory, according to an aspect of the present invention;

FIG. 46 is a perspective view of a side door assembly, according to an aspect of the present invention;

FIG. 47 is a perspective view of a side door assembly, according to an aspect of the present invention;

FIG. 48 is a perspective view of a side door assembly including a panel attachment feature, according to an aspect of the present invention;

FIG. 49A is a perspective view of a side door assembly including a panel attachment feature, according to an aspect of the present invention;

FIG. 49B is a sectional view taken from 49A;

FIG. 50A is an elevation view of a side door assembly including that is a full coverage enclosure panel, according to an aspect of the present invention;

FIG. 50B is a sectional view taken along 50B-50B of FIG. 50A, according to an aspect of the present invention;

FIGS. 50C and 50D are sectional views of door enclosure attachment systems of the door of FIG. 50A, in accordance with aspects of the present invention;

FIG. 51A is an elevation view of a side door assembly including recessed panel mounting locations, according to an aspect of the present invention;

FIG. 51B is a sectional view taken along FIG. 51A depicting recessed outer mounting, according to an aspect of the present invention;

FIG. 51C is a sectional view taken along FIG. 51A depicting recessed inner mounting, according to an aspect of the present invention;

FIG. 51D is a sectional view taken along FIG. 51A depicting recessed even mounting, according to an aspect of the present invention;

FIG. 52A is an elevation view of a front side door assembly and rear side door assembly each including panel mounting variations, according to aspects of the present invention;

FIG. 52B is a sectional view taken along FIG. 52A, A-A depicting an inner mount/flush panel, according to an aspect of the present invention;

FIG. 52C is a sectional view taken along FIG. 52A, A-A depicting an inner mount/flush panel, according to an aspect of the present invention;

FIG. 52D is a sectional view taken along FIG. 52A, B-B depicting an exterior mount/proud panel, according to an aspect of the present invention;

FIG. 53A is a perspective view of a side door assembly including a plurality of removable panels, according to an aspect of the present invention;

FIG. 53B is an elevation view taken along FIG. 53B-53B, according to an aspect of the present invention;

FIG. 54A is an elevation view of a front side door assembly and rear side door assembly each including a metal mesh panel, according to aspects of the present invention;

FIG. 54B is a perspective view of a perimeter halo of FIG. 54A, according to an aspect of the present invention;

FIGS. 55-57 are perspective views of a side door assembly including a vented panel, according to aspects of the present invention;

FIGS. 58A-58B are a perspective views of a panel, according to aspects of the present invention;

FIG. 59 is a perspective view of a side door assembly including a metal construction and mounting features, according to an aspect of the present invention;

FIGS. 60A-60B are perspective views of a side door assembly including a plastic or fiberglass part over a metallic structure, according to aspects of the present invention;

FIG. 61 is a perspective view of a side door assembly including a bump-out for storage space, according to an aspect of the present invention;

FIGS. 62A-62B are perspective views of a side door assembly including a sound or thermal insulation panel or filler, according to aspects of the present invention;

FIG. 63A is a perspective view of a panel attachment to frame or structure, according to aspects of the present invention;

FIG. 63B-63D is a perspective view of a panel attachment with a plurality of fasteners, according to aspects of the present invention;

FIGS. 64A-64B are perspective views of a panel attachment including at least one glide-gasket received in a track or channel, according to aspects of the present invention;

FIGS. 65A-65B are perspective views of a panel attachment including to a J-Rail, according to aspects of the present invention;

FIG. 66 is an exploded perspective view of a panel attachment with a plurality of fasteners and gasket, according to aspects of the present invention;

FIG. 67 is a perspective view of a door structure including a plurality of kink bends, according to an aspect of the present invention;

FIG. 68 is a perspective view of a side door assembly, according to an aspect of the present invention;

FIG. 69 is a perspective view of a side door assembly, according to an aspect of the present invention;

FIG. 70 is a perspective view of a side door assembly, according to an aspect of the present invention;

FIG. 71 is a perspective view of a side door assembly, according to an aspect of the present invention;

FIG. 72 is a perspective view of a side door assembly, according to an aspect of the present invention;

FIGS. 73A-74B are perspective views of a side door assembly, according to an aspect of the present invention;

FIG. 74 is a perspective view of a side door assembly, according to an aspect of the present invention;

FIG. 75 is a perspective view of a side door assembly, according to an aspect of the present invention;

FIG. 76 is a perspective view of a side door assembly, according to an aspect of the present invention;

FIG. 77 is an elevation view of a front side door assembly and rear side door assembly executed on an off-road vehicle/UTV/ATV, according to an aspect of the present invention;

FIGS. 78A-78B are perspective views of a side door assembly including a enclosing ring, in accordance with aspects of the present invention; and

FIGS. 79A-79B are perspective views of a side door assembly, in accordance with aspects of the present invention.

### DETAILED DESCRIPTION OF THE PREFERRED EMBODIMENTS

The following description of the preferred embodiment(s) is merely exemplary in nature and is in no way intended to limit the invention, its application, or uses.

The present invention will become more fully understood from the detailed description and the accompanying drawings, wherein:

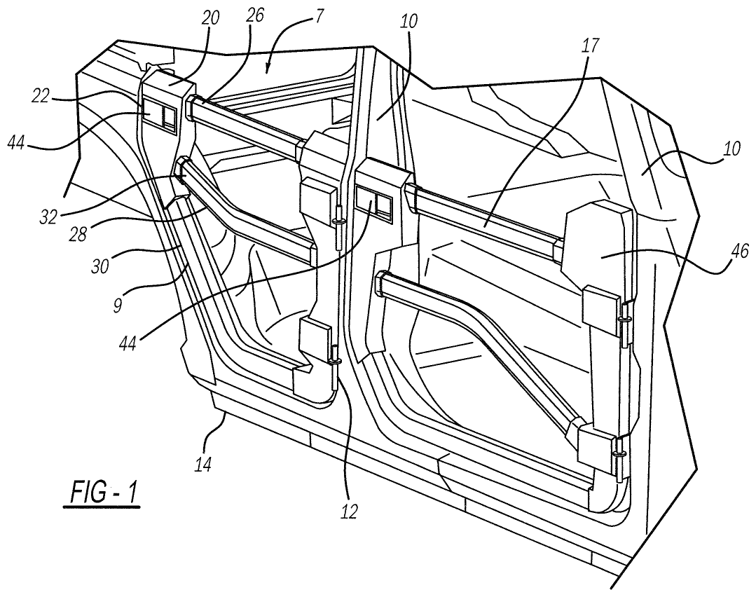

Referring to FIGS. 1 through 3, a side door assembly 7 according to the present invention is provided. The side door assembly 7 is shown utilized to close a side door opening 9 in an automotive vehicle 10. The vehicle 10 shown is a Jeep™ automotive vehicle. As shown, side door assembly 7 is for a rear passenger compartment. Side door assembly 17 illustrates the invention utilized for a front row passenger compartment. Side door assembly 7 has a front casting 10. Casting 10 is typically fabricate from die cast aluminum or titanium. Front casting 10 is provided with upper and lower hinge pins 12 to allow the door 7 to be pivotally connected to the vehicle body 14. Typically the hinge pins are fabricate from stainless steel and are connected to the casting 10 by a press-fit or other suitable attachment method. Door assembly 7 is provided with a rear casting 20. Rear casting 20 is provided with a latch handle 22, which controls a latch mechanism (not shown) to allow the assembly to have a latched connection with vehicle body 14.

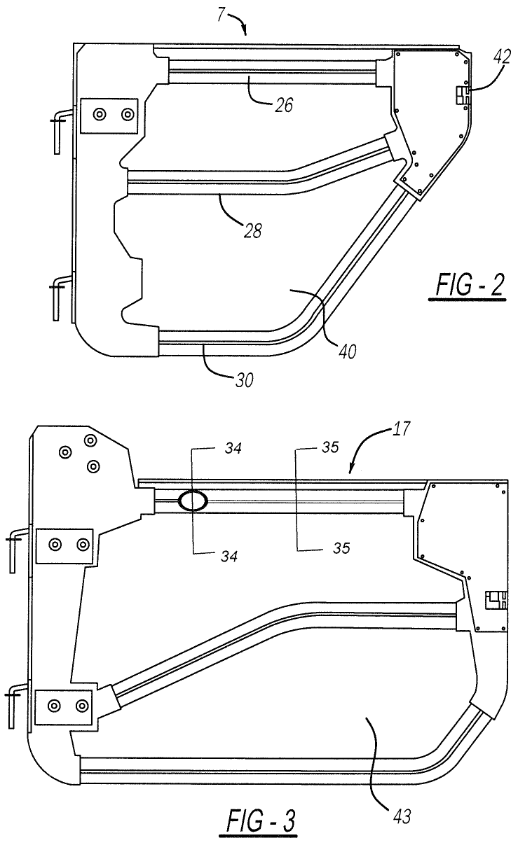

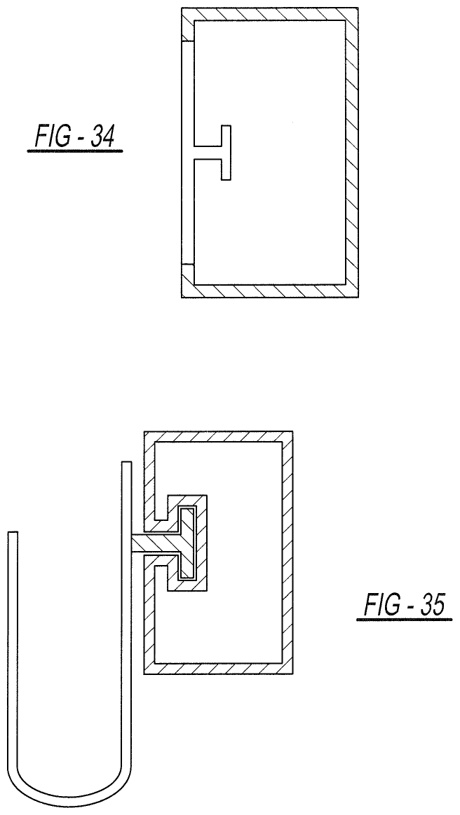

A tubular extrusion 26, fabricated from aluminum or titanium, connects front casting 10 to the rear casting 20. It will be readily appreciated that the extrusion is shown as tubular but can be ‘L’ shaped or have other cross-sectional shapes. As shown, door assembly 7 has two additional connective extrusions 28 and 30. Extrusion 28 has an end 32 that is connected with the rear casting 20 at a higher elevation than its frontend 34 with the front casting 10. Lower extrusion 30 has a bend 36 forming a lower portion bordering the side door opening 9. An interior side of lower extrusion 30 and lower portion of the front casting 10 have a channel mounting a sealing bulb to seal the bottom portion door assembly 7 with the door opening 9. FIG. 2 is a view of the door assembly shown in FIG. 1 from the interior of the vehicle. In FIG. 2 an outer skin 40 has been added. The upper extrusion 36 and the middle extrusion 28 have a T-slot feature (see FIGS. 34 and 35) for attachment of add-on accessories. Lower extrusion 30 also has the T-slot. A cable operated by latch handle 44 (FIG. 1) can extend through an interior of the top extrusion 26 to operate a two-stage rotary latch with anti-rattle overmold 42. Referring back to FIG. 1, latch handle 44 is a Jeep TJ-style panel latch and is at the same elevation as latch handle 22 for styling purposes. Door assembly 17 is constructed in a manner similar to that of door assembly 17, however door assembly 17 additionally has a tower 46 to allow for attachment of the rear view mirror and associated hardware.

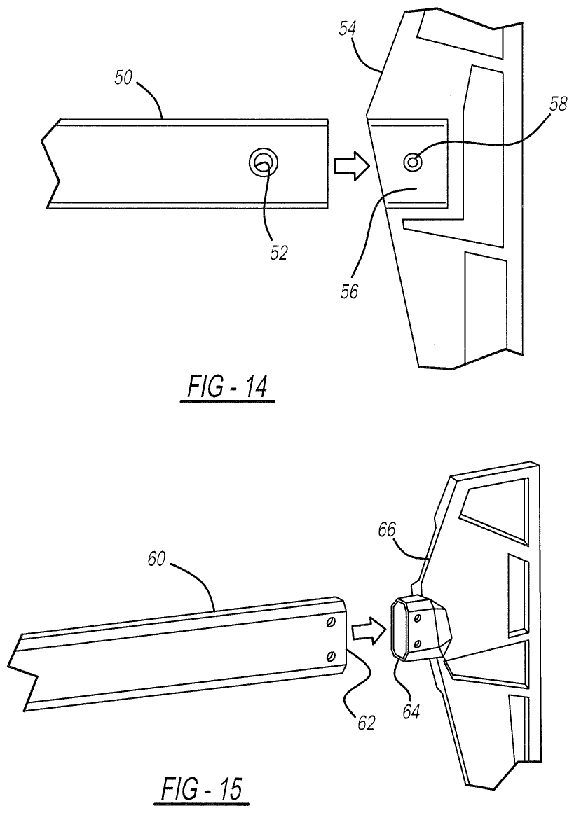

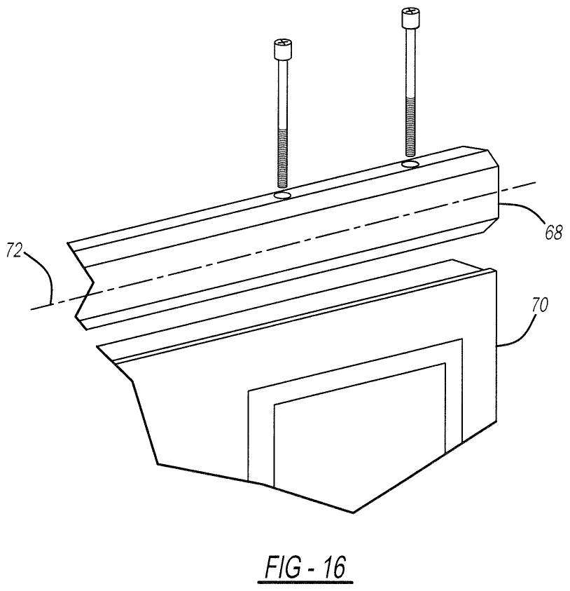

Referring to FIG. 14, various attachment methods are illustrated. In FIG. 14 an extrusion 50 has an aperture 52 allowing it to be boltably connected to a casting 54 by a fastener with a front or rear end of the extrusion being placed within a pocket 56 provided in the casting with a matching fastener hole 58. Typically the fastener is connected from the inside to prevent it showing on the exterior of the vehicle. In FIG. 15 an extrusion 60 has a female opening fitted over a male stud 64 of a casting 66. In FIG. 16 an extrusion 68 is abuttingly connected with a casting 70 by bolts extending through extrusion 68 transverse to its longitudinal axis 72.

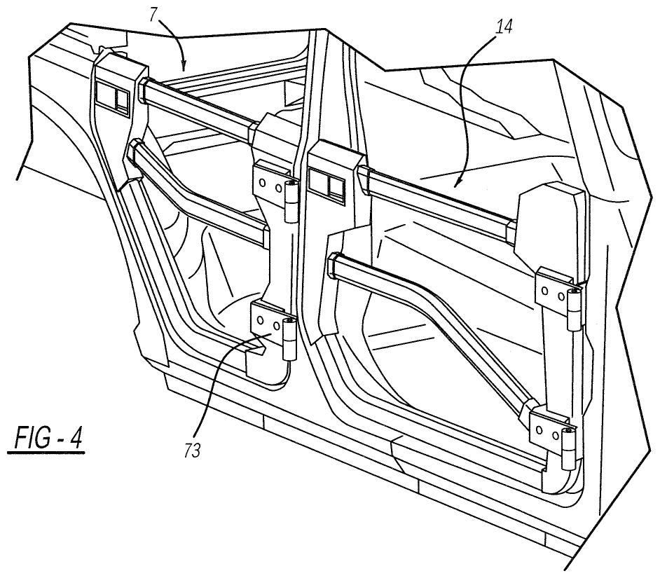

FIGS. 5 and 4 illustrate the door assemblies 7 and 17 with alternative hinge pin arrangement 73. The hinge pin arrangement 73 is typically utilized in external hinge pin arrangements. Additionally, in FIG. 5, the door assemblies 7 and 17 are shown with an exterior door panel 40 and 43.

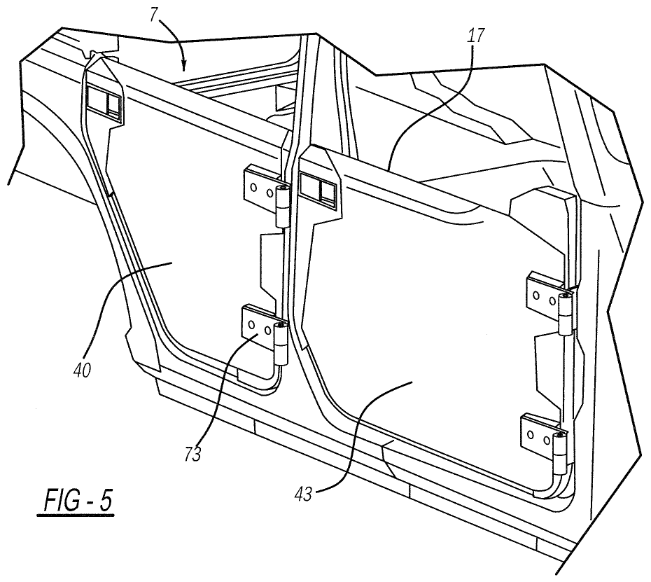

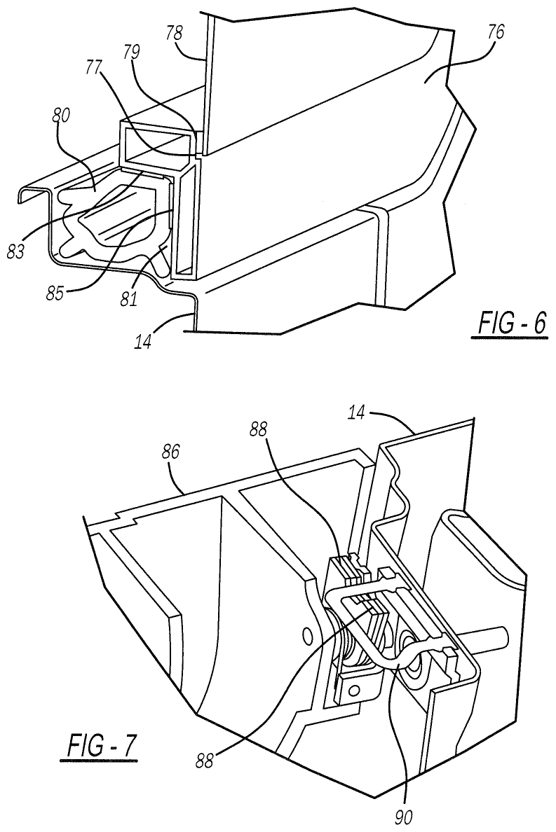

FIG. 6 illustrates a bottom portion of a lower extrusion 76 having a recess 77 for acceptance of an outer panel 78. The panel 78 is partially sealed by a preform or applied sealant 79. The sealant and panel 78 are fitted in the recess 77. The extrusion 76 also has an open groove 81 having generally perpendicular wall 83 (as shown horizontally) and 85 (shown vertically) that adhesively connect a sealing bulb or weather strip 80 to seal a lower portion of the door opening.

FIG. 7 illustrates a rear casting 86 mounting latched hardware 88 for engagement with a striker 90 connected with the vehicle body 14.

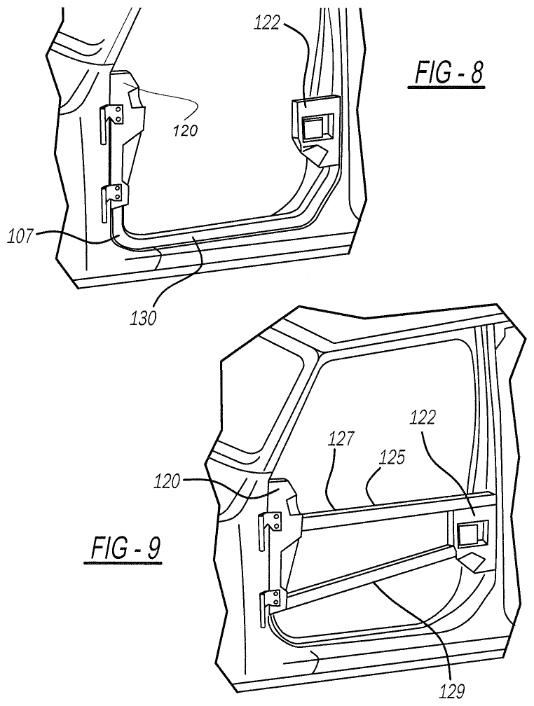

FIG. 8 illustrates a door assembly 107 having a front casting 120 and a rear casting 122 joined only by a lower extrusion 130.

FIG. 9 illustrates a door assembly 127 having a front casting 120 and a rear casting 122 connected by an upper extrusion 125 and a midpoint extrusion 129 forming a quarter door.

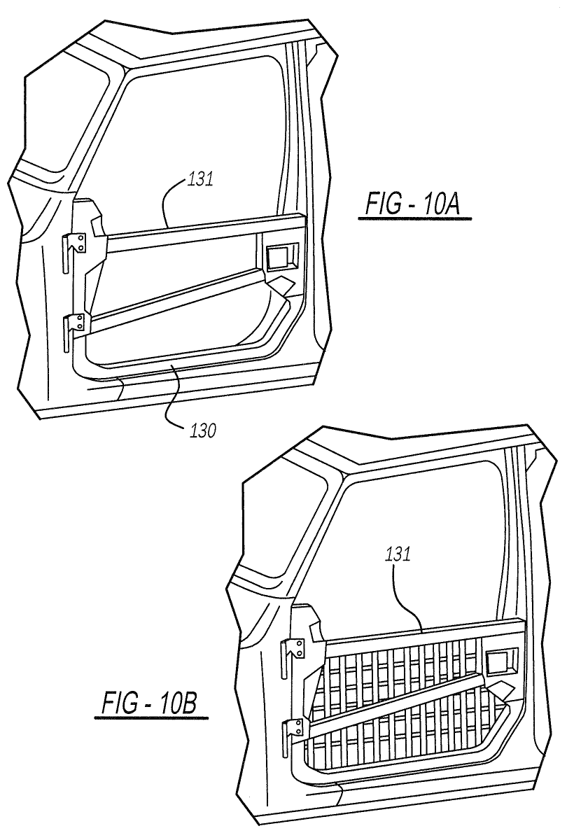

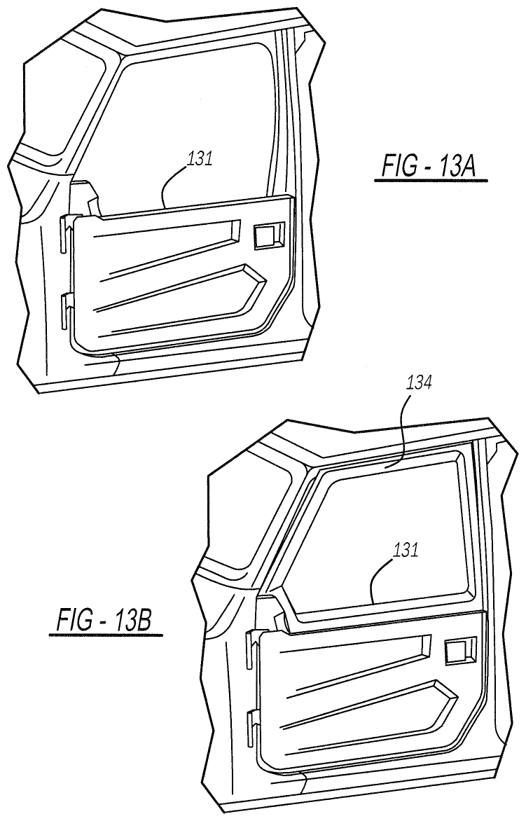

FIG. 10A illustrates door assembly 131, essentially identical to door assembly 172 with an addition of a lower extrusion 130A. The door assembly 131 is typically referred to as a half-door assembly. The half door in FIG. 10B illustrates the door 131A with the addition of a racing net. FIG. 13A illustrates the door assembly 131 with the addition of an outer door panel. Typically, the outer panel is an aluminum stamping, vacuum-formed plastic or durable fabric. Door assembly 131 in FIGS. 10A and 10B, and in 13A are commonly referred to as half doors. FIG. 13B is essentially identical to the door assembly 131, however 13A additionally has an added window frame 134 and is commonly referred to as a full door.

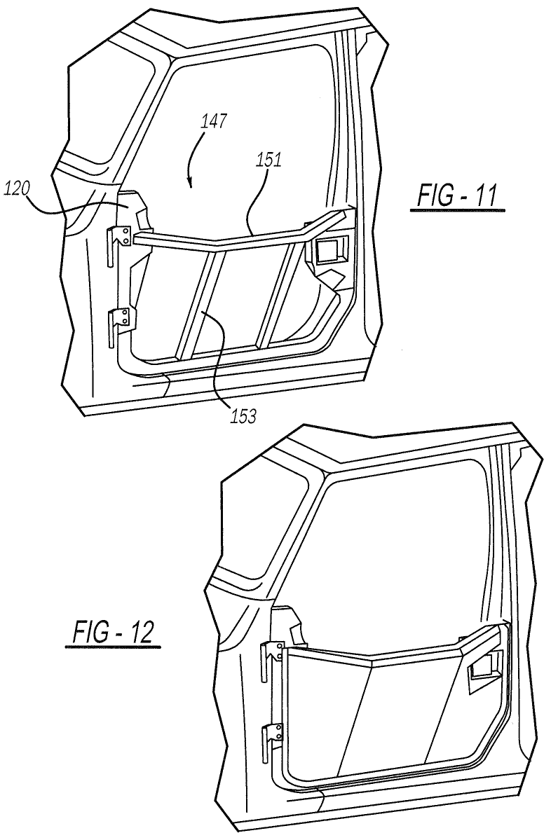

FIG. 11 provides a door assembly 147 of a half door with front and rear castings 120 and 122. Door assembly 147 has an upper extrusion 151 that is arcuately bent outboard extending away from the vehicle body. Extrusion 151 is joined by two generally vertically inclined extrusions 153 that connect with the lower extrusion 130. FIG. 12 illustrates the door assembly as shown in FIG. 11 covered with an outer panel of material similar to that as noted in the door assembly described in 13A and 13B.

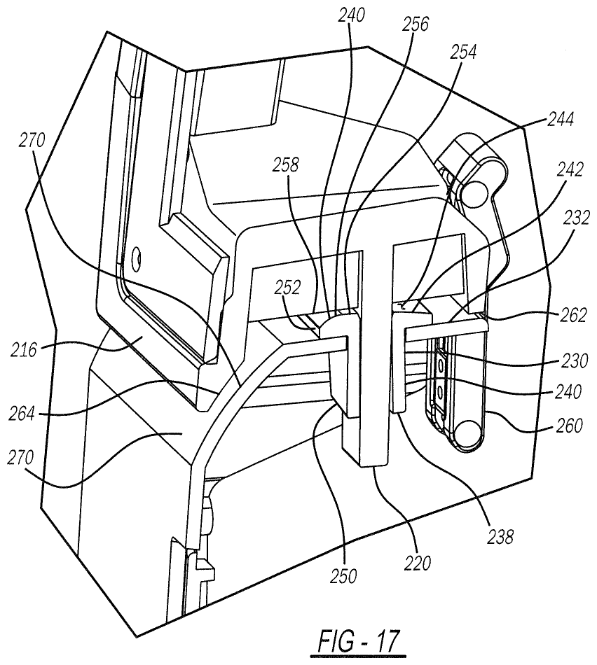

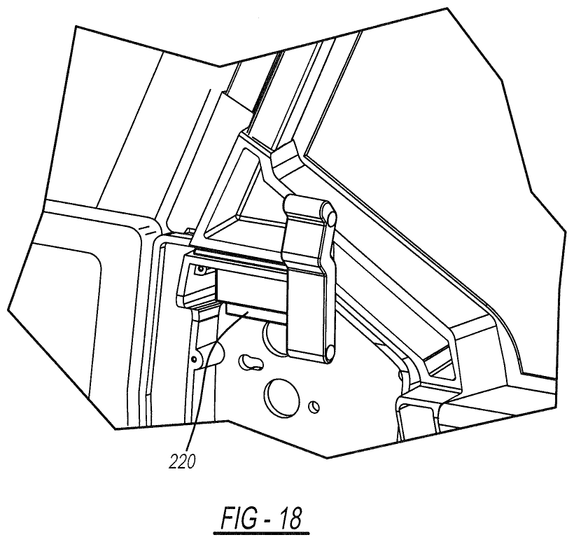

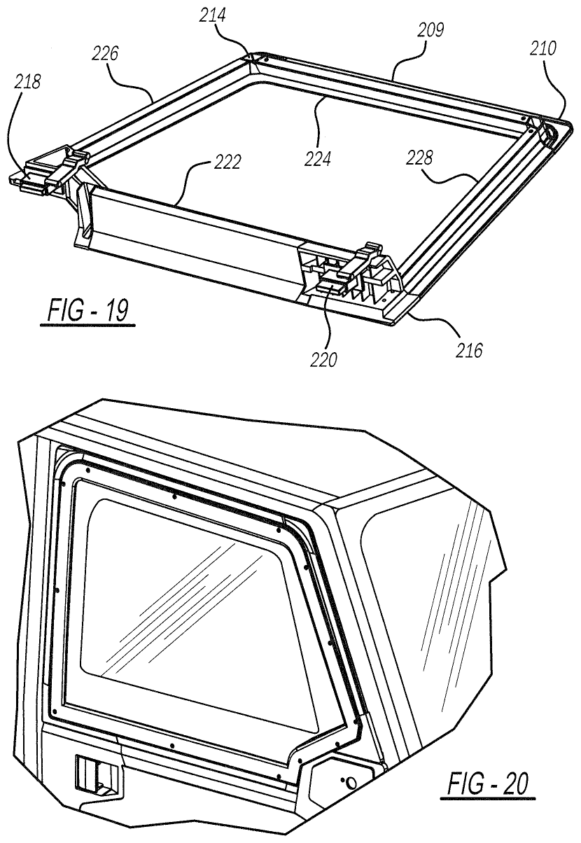

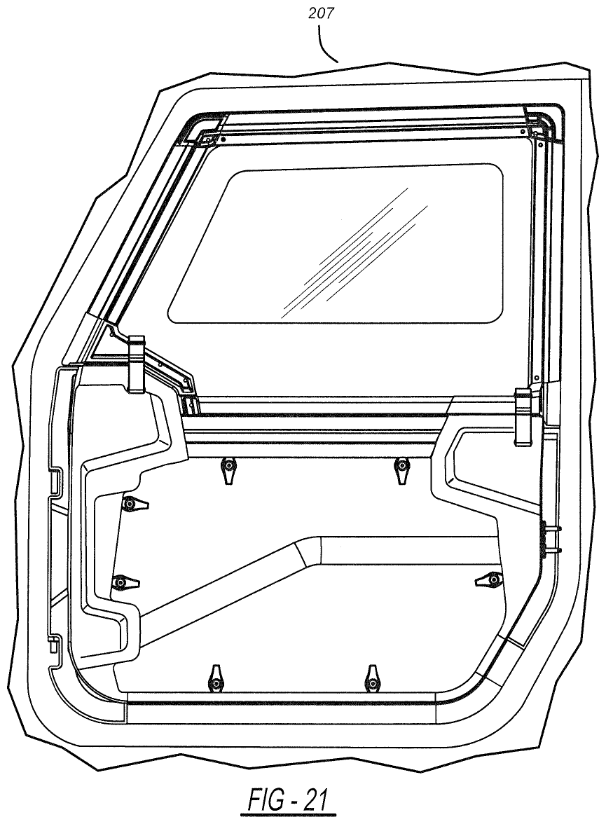

Referring to FIGS. 17 through 21, a door assembly 207 is provided having a connected window frame 209. Window frame 209 is fabricated from an upper rear casting 210, an upper front casting 214, a lower rear casting 216 and a lower front casting 218. Typically the fabrication material will be the same as for the door casting as previously described. The lower rear casting 216 and the front door casting 218 both have mounting blades 220. The lower castings 216 and 218 are connected with a lower extrusion 222. Castings 214 and 210 are connected by an upper extrusion 224. Castings 214 and 218 are joined by an extrusion 226, and castings 210 and 216 are connected by an extrusion 228. The rear window frame casting blade 220 extends into an aperture 230 formed on a generally flat horizontal portion 232 of a rear casting 236 of the door assembly. The blade 220 juxtaposes elastomeric inserts 238 and 240. Typically the longitudinal length of the elastomeric inserts 238 and 240 will be slightly larger than that of blade 220. Insert 238 has a generally vertical portion 240 joining to a generally horizontal portion 242. Horizontal portion 242 has a generally inclined top surface 244. Opposite elastomeric insert 240 has a generally vertical portion 250 joining to a horizontal portion 252. Horizontal portion 252 has a generally horizontal surface 254 blending into arcuate declining surface 256 and a vertical surface 258. An elastomeric strap 260 I provided for pulling down the door frame to the remainder of the door assembly. A horizontal surface 262 of the window casting 216 abuts the flat portion 242 of the door casting 236. Window casting 216 has an arcuate curvilinear edge 264 having mating contact with a downward incline curvilinear edge portion 270 of the door assembly rear casting 236. The blade 220 of window front casting 218 also fits an aperture of a front casting 272 of the door assembly. However, it is at a higher elevation than the blade 220 of the rear window casting. The details of elastomeric inserts of the front lower casting 218 of the window are essentially identical to those previously described.

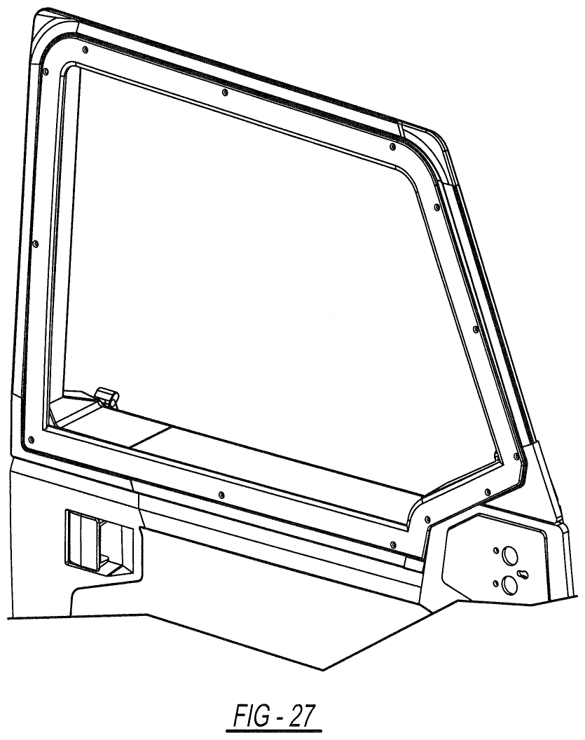

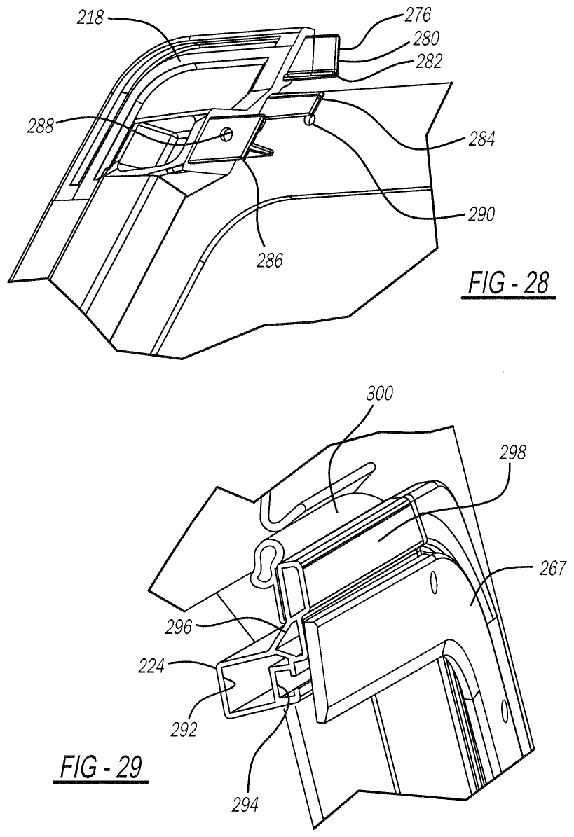

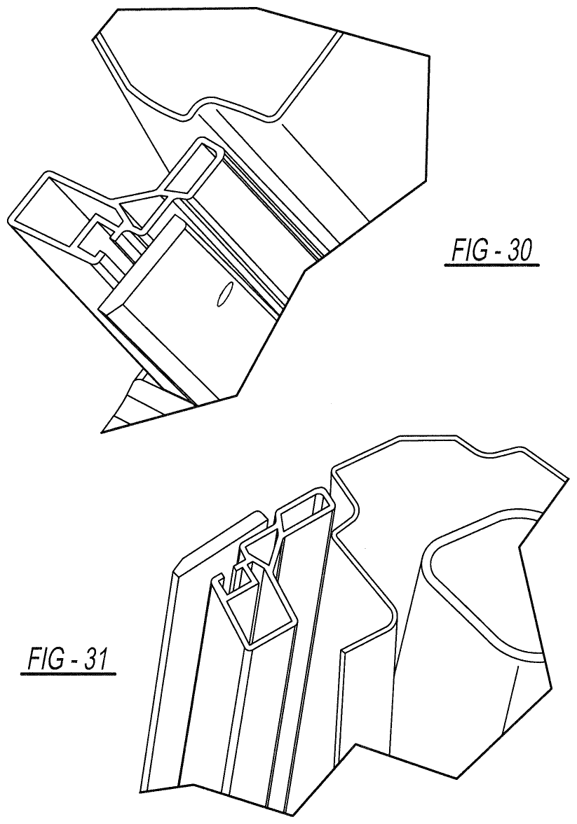

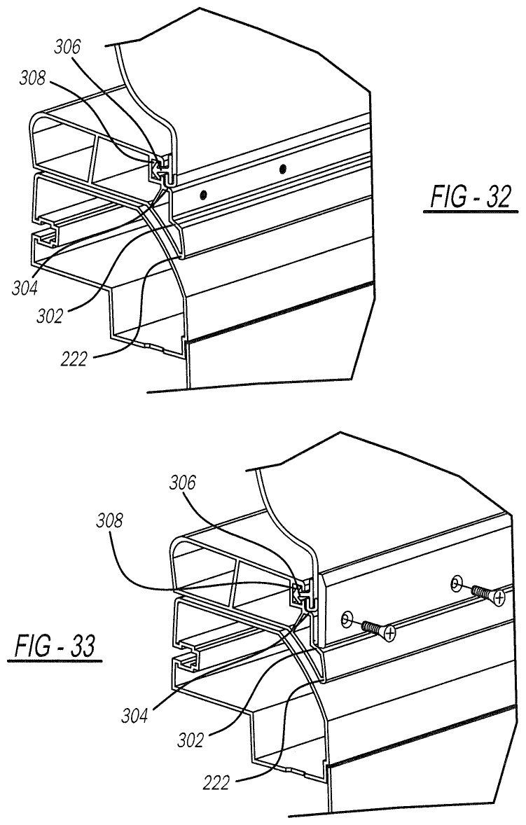

FIGS. 28 through 33 illustrate further detail of the window frame 209. Referring in particular to FIG. 28, window casting 214 has a first male member 276, including a main male member 280 and a stud male member 282. A second male member 284 is also provided and a T-shaped cross sectional third male member 286 is also provided. Male member 286 has an aperture 288 to allow for connection of extrusion 224 to the casting 214 trim piece (sometimes referred to as a trim ring), which has an aperture 290 to allow for its bolted connection to the extrusion 224. The extrusion 224 has a channel 292 for reception of the male member 286 and the corresponding male member of window frame casting 210. Extrusion 224 also has a channel 294 for acceptance of an arrowhead extrusion utilized in maintaining the soft goods attachment of a twill carrier. Extrusion 224 has another channel 296, generally triangular in shape, for reception of male member 284 and for providing a surface for connection of the trim piece 267. Extrusion 224 also has a fourth channel 298. Channel 298 accepts male member 276 and supports a sealing bulb 300 that compressively loads and seals the window frame of the vehicle door opening. Seal 330 is typically adhesively connected with the channel 298.

The method of soft goods attachment is for lower extrusion 222 to have a first step 302 for support of the trim piece 267 and a higher step 304 supporting an arrowhead-type extrusion 306, which is sewn to a trill carrier arrowhead extension 306, fitted within a channel 308 similar to the channel 294 previously described.

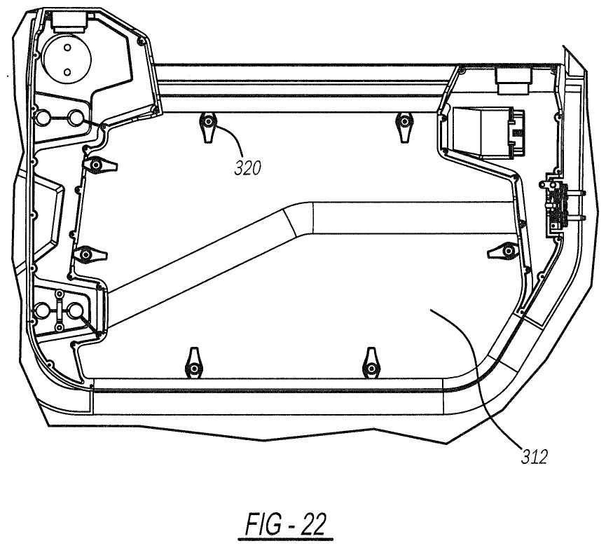

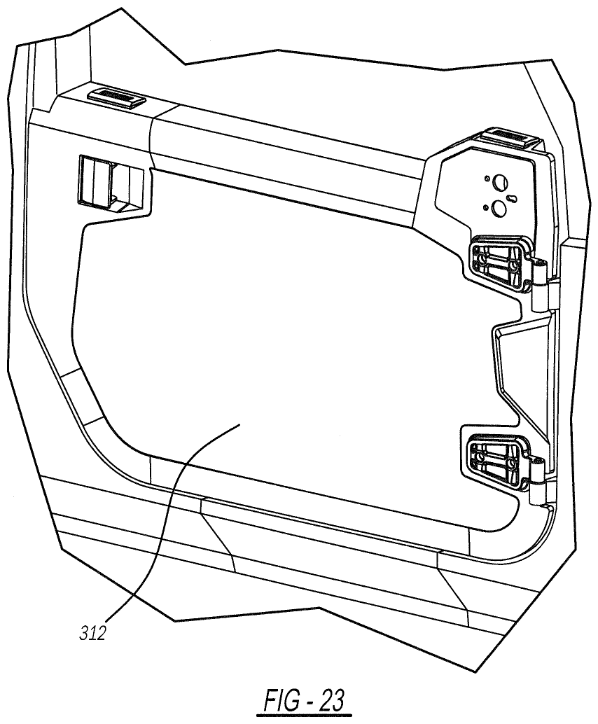

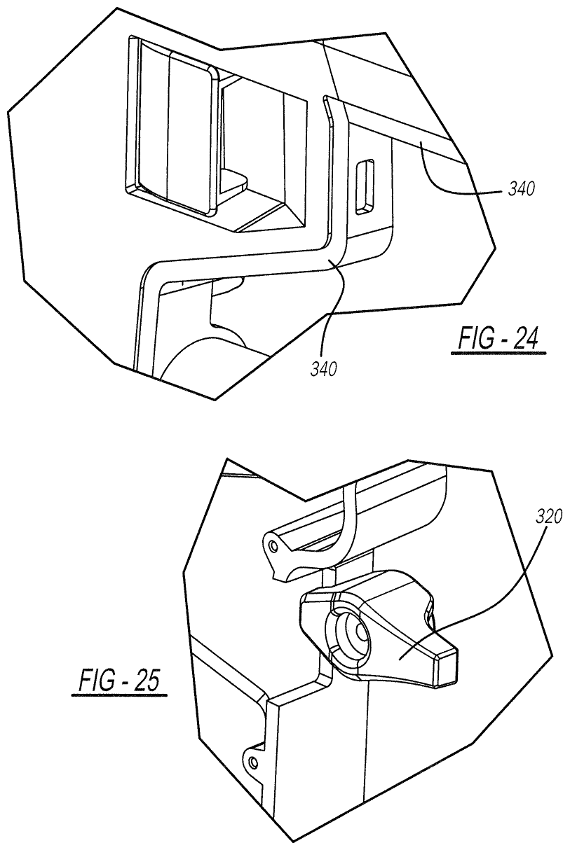

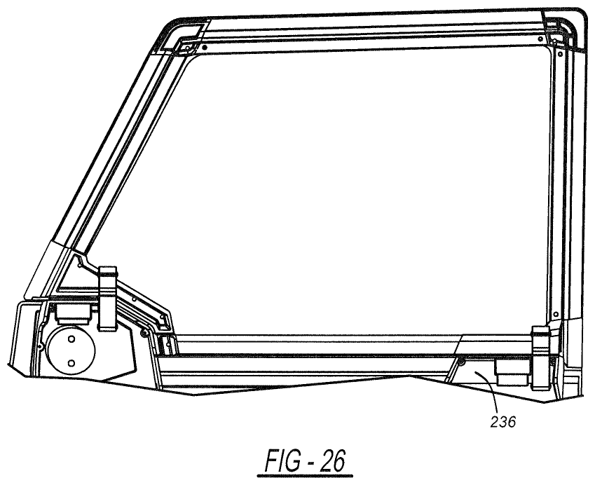

Referring additionally to FIGS. 22 through 25, door assembly 207 is provided with an outer panel 312. Outer panel 312 is connected to front and rear door castings by a series of toggle switches 320. Toggle switches also connect the outer panel 312 to upper and lower extrusions. The extrusions and the front and rear castings have a recess 340 allowing the door panel to have a seamless look.

The door assembly 207 has a series of door hinges 350 that are symmetrical and can be used in the front and rear inside and outside, or left and right side of a vehicle utilizing the same.

Referring now to FIGS. 36 and 37, there is shown a half door assembly which includes a portion 302 that extends outward from the door framework 300 of a vehicle. As shown in these figures a door frame portion 300 is hingedly attached to the vehicle 310. The door framework portion substantially fits within the door opening of the vehicle and substantially matches the planar vertical and horizontal planar surfaces of the vehicle 310. The side structure 302 extend outwardly form the vehicle to form a three dimensional shape which extends outwardly from the planar surface of the vehicle 310.

As shown in FIG. 36 the structure 302 can be bolted or welded to the framework 300 of the door. A panel such as 304 can be bolted to the framework or otherwise attached such as by welding if desired. Panels 302a and 302b also form a three-dimensional structure outside the planar surface of the vehicle and are attached either to the door framework or to the portion 302 depending on the desired final construction.

In the embodiment shown in FIG. 36 the bump out portion slopes outward from the bottom 306 to the top 308 as shown in the drawings.

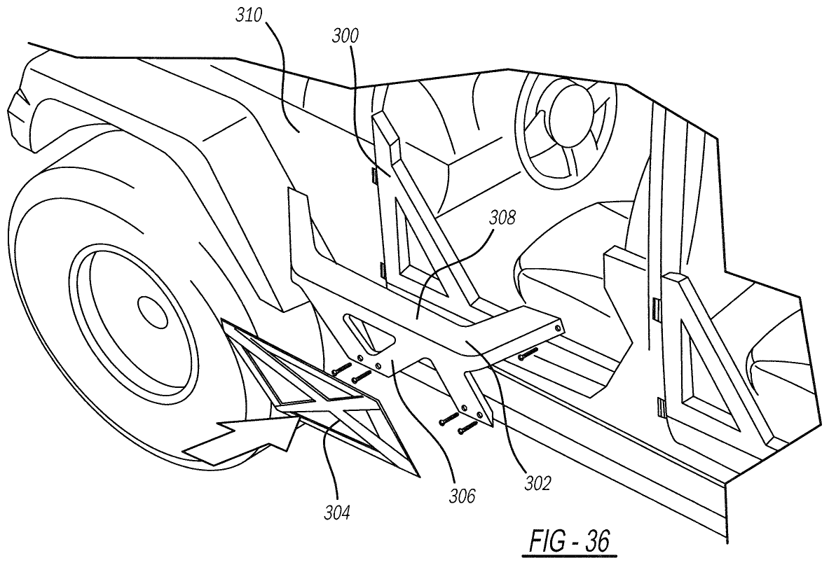

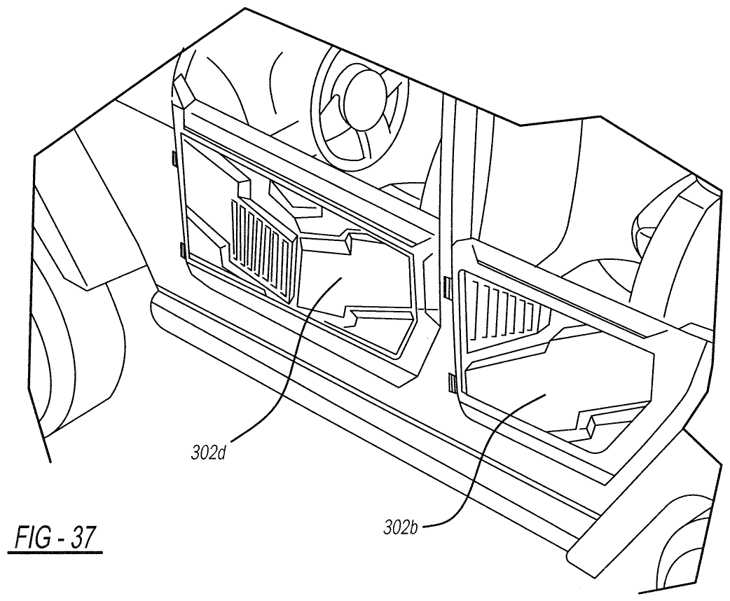

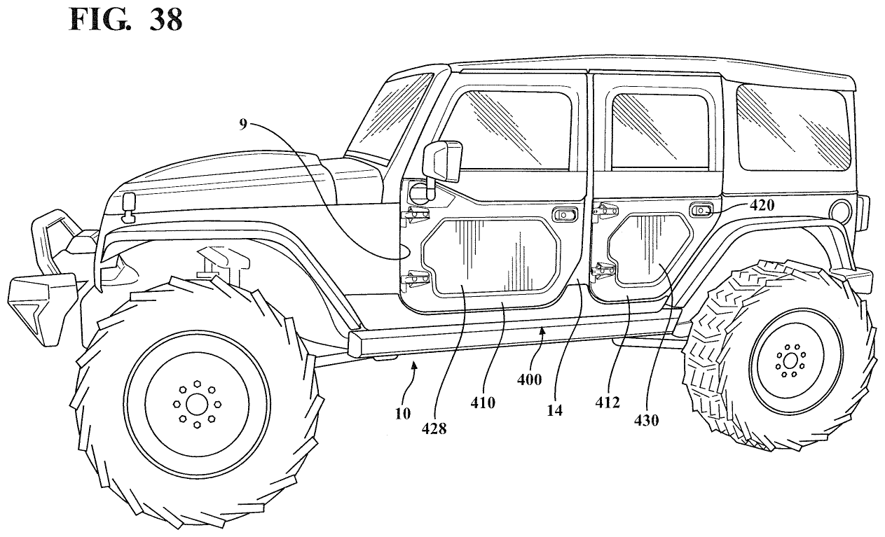

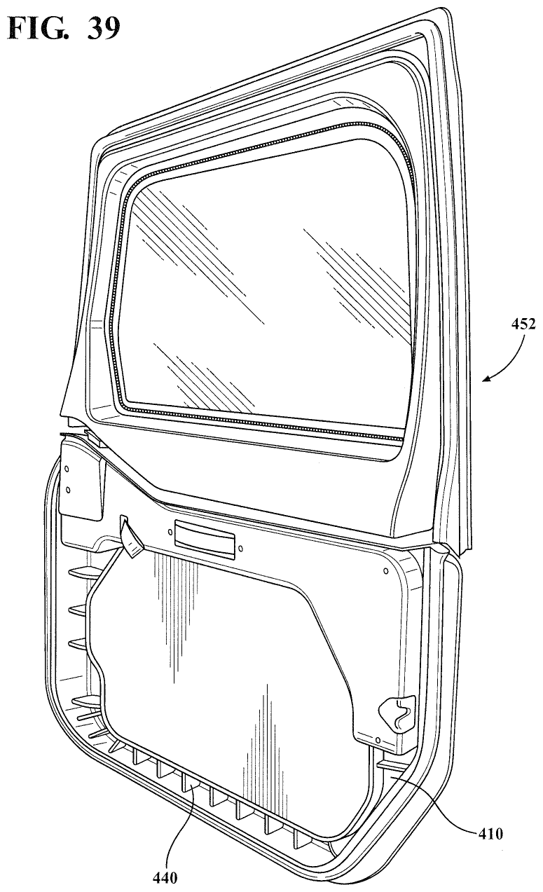

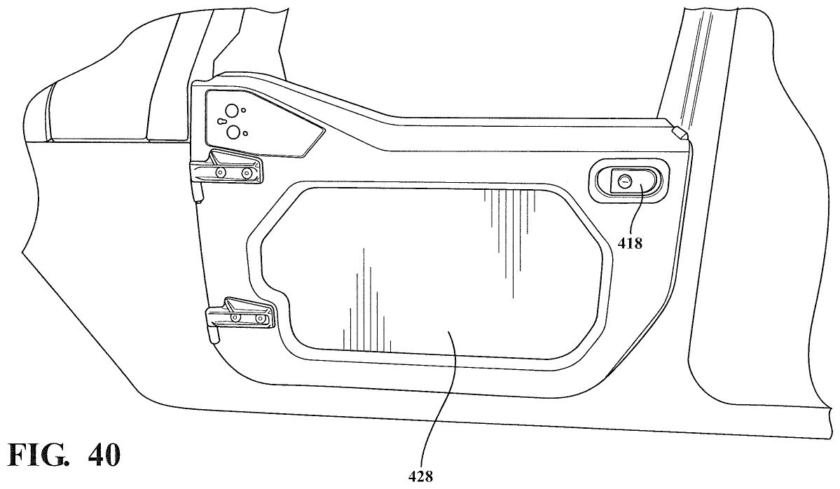

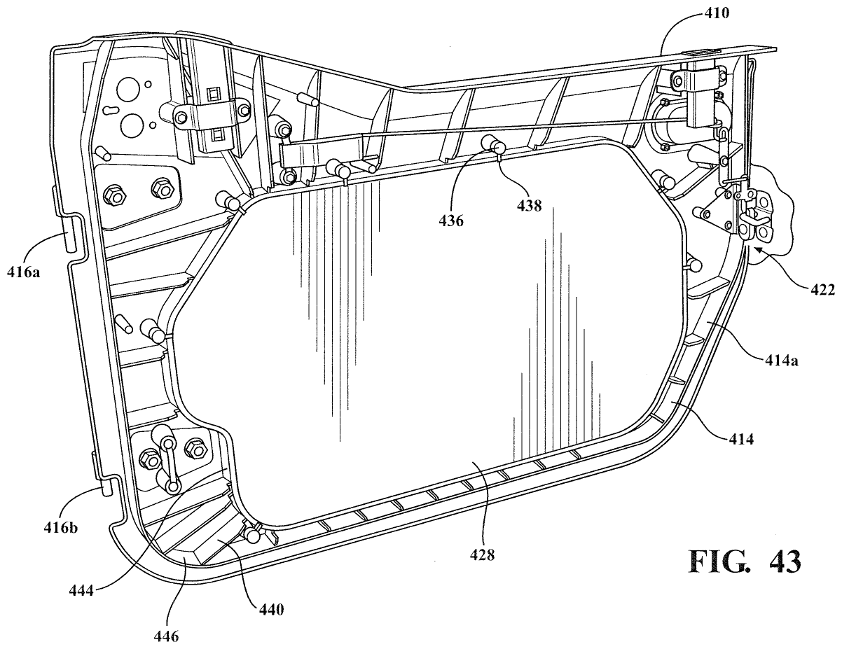

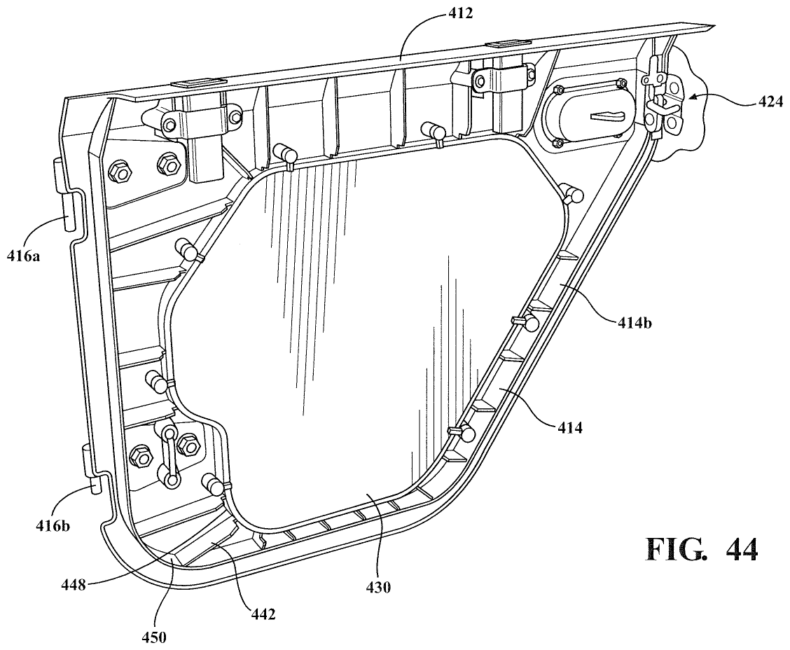

Referring now to FIGS. 38-44 generally, there is provided a side door assembly shown generally at 400 according to the present invention. The side door assembly 400 is shown utilized to close a side door opening 9 in an automotive vehicle 10. The vehicle 10 shown is a Jeep™ automotive vehicle. Alternative sport utilities vehicles are contemplated without departure from the scope of the present invention. As shown, a front side door assembly 410 is for the front row passenger compartment, and a rear side door assembly 412 is for a rear passenger compartment. The side door assemblies 410,412 each have a one piece casting 414. The front 410 has a one-piece casting 414a, and the rear 412 has a one-piece casting 414b. The one-piece casting 414 is typically fabricated from die cast aluminum or titanium. Preferably, the casting includes a powder coated finish.

Preferably, the casting 414 is provided with upper and lower hinge pins 416a,416b to allow each door 410 and 412 to be pivotally connected to the vehicle body 14. Hinge pins 416a,416b operably connect the casting 414a of the front side door assembly 410 to the vehicle body 14, and a second pair of hinge pins 416a,416b connect the casting 414b of the rear side door assembly 410 to the vehicle body 14. Typically, the hinge pins 416a,416b are fabricate from stainless steel and are connected to the casting 414 by a press-fit or other suitable attachment method. Each door assembly 410,412 is provided with a latch handle 418 and 420, respectively, which controls a latch mechanism, generally shown at 422 and 424, respectively, to allow the assembly to have a latched connection with vehicle body 14.

Most preferably, the side door assembly 400 has no additional castings. More preferably, the side door assembly 400 includes a one-piece casting and has no extrusion connecting front and rear castings.

A cable operated by latch handle can extend through an interior of the casting to operate a two-stage rotary latch with anti-rattle overmold, Preferably, the front latch handle is a TJ-style panel latch and is at the same elevation as rear latch handle for styling purposes.

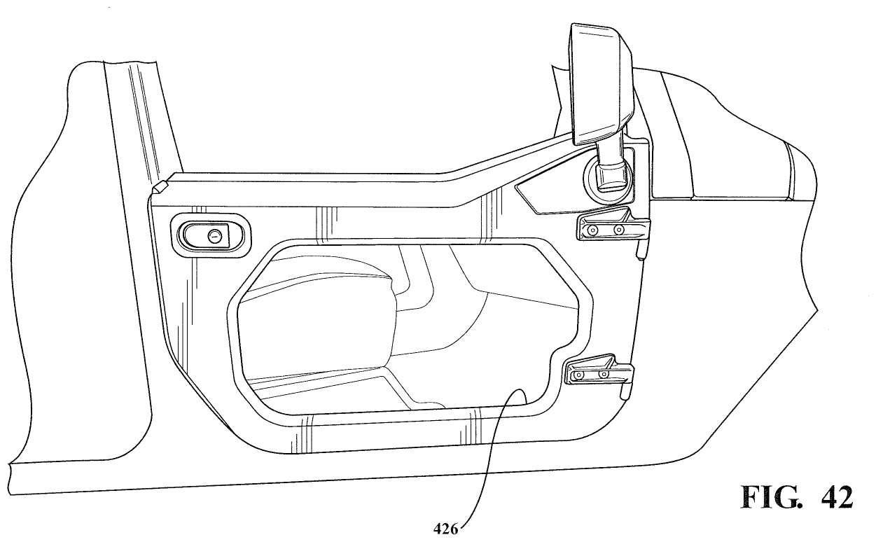

The casting 414a is provided with an opening 426. FIG. 42 illustrates no cover or panel within, over or behind the opening 426. The vehicle interior is exposed through the opening. Optionally, a netting (FIG. 10B), bag, canvas bag, straps, webbing, or any other suitable add-on feature can be added over the opening, most preferably, from the interior of the vehicle.

In FIGS. 38-40 and 43-44, the door assemblies 410 and 412 are shown with a door panel 428 and 430, respectively, preferably, an interior door panel. The door panel 428 and 430 is by way of non-limiting example fabric, plastic, etc. Preferably, the door panel 428 and 430 is not transparent and cannot be seen through. Most preferably, the door panels 428, 430 are molded plastic panels.

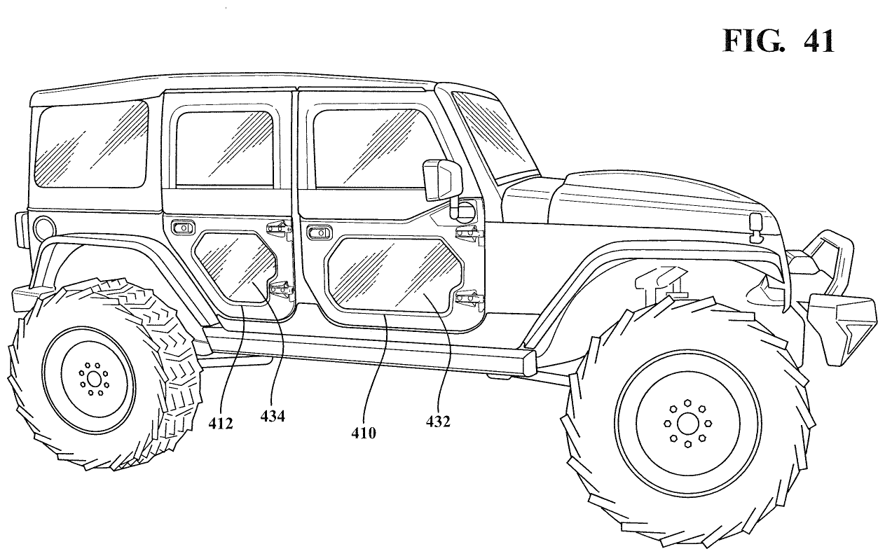

FIG. 41 depicts an alternative interior door panel 432 and 434 that is transparent. The material is, by way of non-limiting example, glass, vinyl, plastic, etc.

Any alternative interior door panels, such as bump out, are contemplated depending on the application, without departure from the scope of the present invention. The side door assembly 400 is modular allowing for any combination of add-on features and interior door panels to be used as desired.

The interior door panels are connected to the one-piece casting by a plurality of rotary attachment mechanisms 436 each having a tab 438 to secure the respective interior door panel to the one-piece casting. The rotary attachment mechanisms 436 are provided on the one-piece castings 414a and 414b.

To secure the interior door panel 428 to the one-piece casting 414a of the front side door assembly 410, the panel 428, taken from the interior of the vehicle is placed over the rear of the opening 426 of the casting 414a and secured by the plurality of rotary attachment mechanisms 436 and held in place by the plurality of tabs 438 pressing on the panel 428 from the direction of the vehicle interior. The other panels 428,432,434 are secured to the respective one-piece castings 414a and 414b in identical manner.

By way of non-limiting example, the rotary attachment mechanisms 436 are toggle switches.

The one-piece casting 414a includes a plurality of structural reinforcements 440 adding structure to the casting 414a. Preferably the reinforcements 440 are webs or ribs. Most preferably, the plurality of reinforcements 440 generally extend from the opening 426 wall 444 to at least one outer wall 446 of the frame 410.

The one-piece casting 414b includes a plurality of structural reinforcements 442 adding structure to the casting 414b. Preferably the reinforcements 442 are webs or ribs. Most preferably, the plurality of reinforcements 442 generally extend from the opening 426 wall 448 to at least one outer wall 450 of the frame 412.

The structural reinforcements 440 and 442 give strength where needed. Preferably, the structural reinforcements 440 and 442 extend from every side of the opening wall.

FIG. 39 is essentially identical to the door assembly 410 however FIG. 39 additionally has an added window frame depicted generally at 452 and is commonly referred to as a full door. The window frame is preferably identical as added window frame 134 described previously and is commonly referred to as a full door.

While a Jeep is illustrated, it is understood that the present invention is with any vehicle, including but not limited to, sport utility vehicles, motor vehicles, UTVs utility terrain vehicle, side by sides, ATVs all-terrain vehicles, off-road vehicles, racing vehicles, golf karts, trucks, pickup trucks, marine vehicles, boats, etc.

Referring to all of the Figures generally and the previous descriptions, alternatives of core door execution are incorporated throughout the present application.

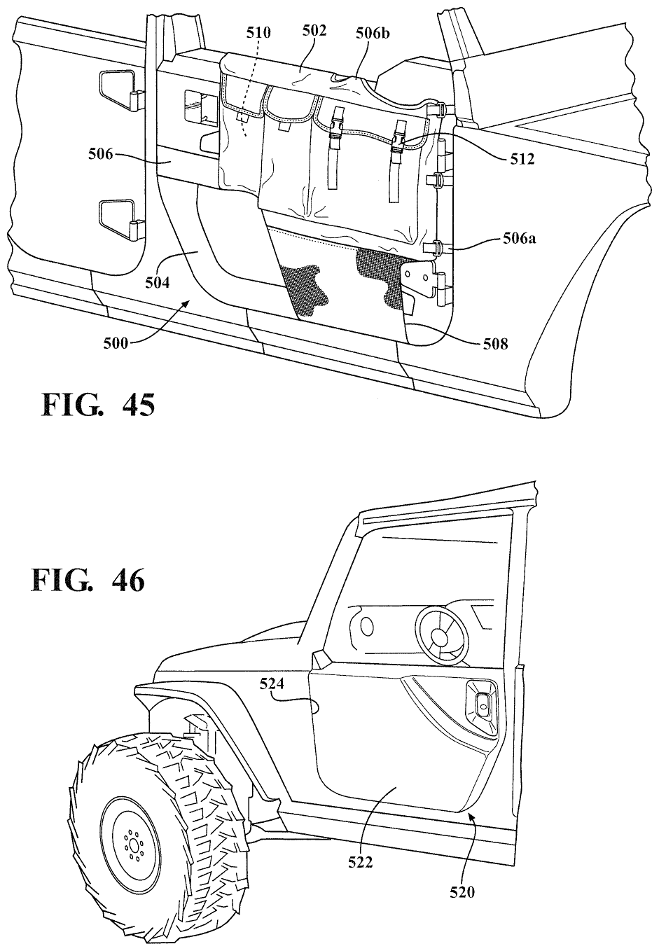

FIG. 45 illustrates a door assembly 500 with an exemplary add-on feature or accessory 502 that is at least one bag, e.g. canvas bag, most preferably, a multi-compartment storage bag. The bag 502 is operably attached to the door structure 504. At least one predetermined fastener attaches the bag 502 to the door 504. At least one strap is preferred, e.g., Velcro strap(s) 506 and loop fastener strap(s) 506a, and top strap 506b or a saddle. The bag 502 preferably has at least one map pocket 508 or other pocket(s) and a plurality of compartments 510 that close. Preferably, the compartments include fasteners to close-off such as snap fit buckles, Velcro, etc. The add-on feature 502 is adaptable for any modular side door assembly depicted or described throughout this application.

The door is adaptable with any alternative features and combinations thereof, open door lower, interior door panels, such as bump out, clear, and add-on accessories, etc and combinations thereof incorporated herein, all of which are contemplated depending on the application, without departure from the scope of the present invention. The side door assembly is modular allowing for any combination of add-on features and interior door panels to be used as desired.

FIG. 46 depicts a side door assembly 520 that includes a hard panel door 522 operably attached to a vehicle 524, e.g., hinged directly to the vehicle, and optionally or alternatively, to a door frame and/or upper door, in accordance with an aspect of the present invention. The panel 522 is a full coverage enclosure panel. The door is depicted as a front door, but is adaptable to be a rear door. It is understood that right side door assembly is a mirror image to the left side door assembly. It is further understood that the assembly is readily adaptable for a front side door assembly and for a rear side door assembly of the present invention, and that while one may be depicted—this present invention is not limited to either a front door or a rear door. The door panel (and side door assembly 520) are adaptable for any modular side door assembly and features, e.g., add-on accessories, accessory attachment methods, core door executions, door structure, steel metal structures, enclosure panels, enclosure panel materials, front side doors (right/left) assemblies, rear side doors (right/left) assemblies, door structure, door panels, removable panels, removable panel schemes, removable panel structures and variations, etc. and in any combinations thereof, depicted or described throughout this application.

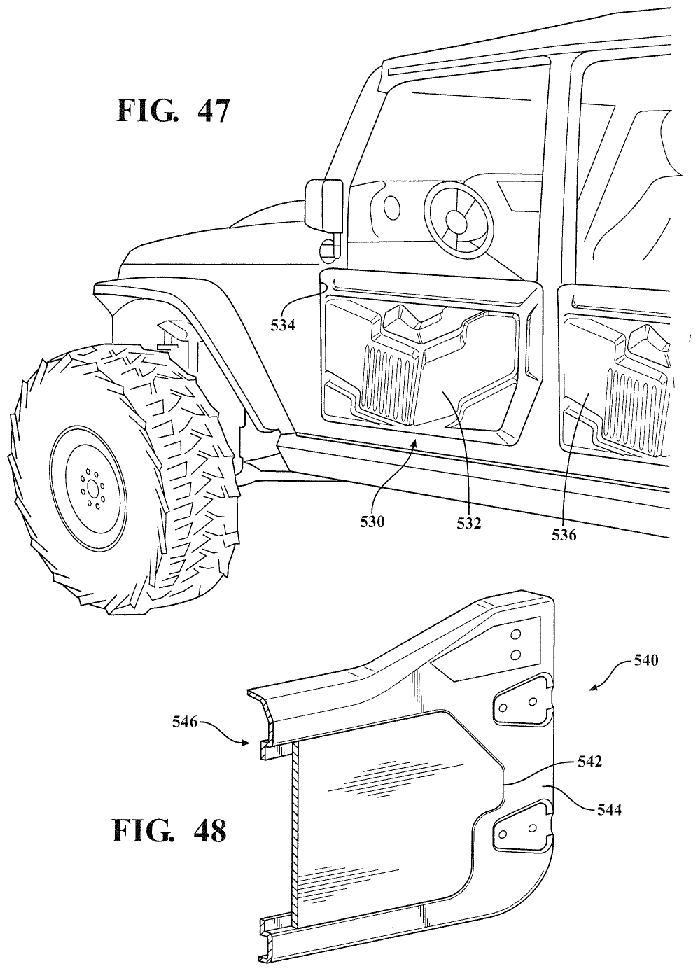

FIG. 47 depicts a side door assembly 530 that includes a panel door 532 with a bump out, in accordance with an aspect of the present invention. The door is operably attached to the vehicle 534. A rear door 536 with a bump out is also depicted, in accordance with an aspect of the present invention. It is understood that right side door assembly is a mirror image to the left side door assembly. It is further understood that the assembly is readily adaptable for a front side door assembly and for a rear side door assembly of the present invention, and that while one may be depicted—this present invention is not limited to either a front door or a rear door. The door panel (and side door assembly 530) are adaptable for any modular side door assembly and features, e.g., add-on accessories, accessory attachment methods, core door executions, door structure, steel metal structures, enclosure panels, enclosure panel materials, front side doors (right/left) assemblies, rear side doors (right/left) assemblies, door structure, door panels, removable panels, removable panel schemes, removable panel structures and variations, etc. and in any combinations thereof, depicted or described throughout this application.

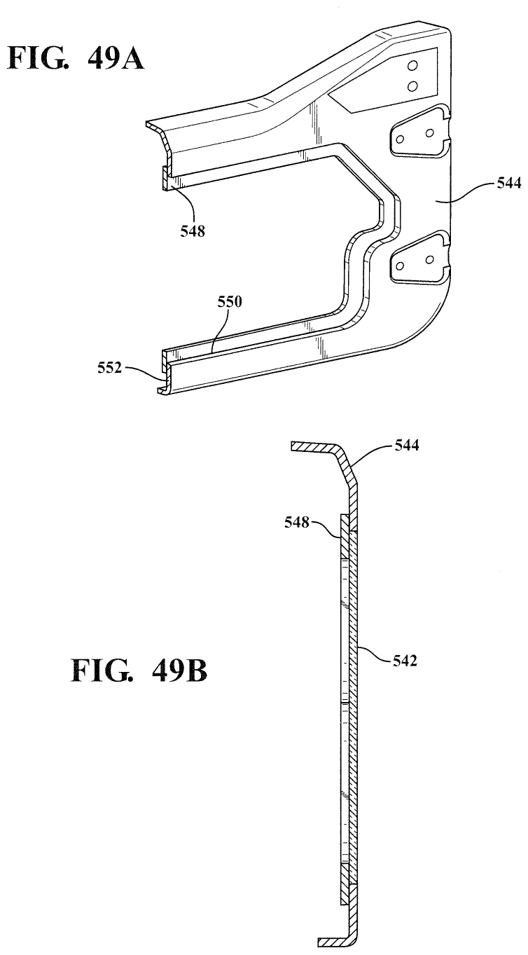

Referring now to FIGS. 48, 49A to 49B, there is depicted a panel attachment feature and clear panel execution, in accordance with an aspect of the present invention. A side door assembly is shown generally at 540, including a door panel 542 and a door structure 544. A lip feature shown generally at 546 allows for attachment of the door panel 542. The lip feature 546 is cast molded with the door structure 544 or the lip feature 546 is created with stamping/bead rolling/brake operation or any other suitable forming operation and any combinations thereof. The door panel 542 or “filler” is formed of at least one predetermined material. A clear execution for the door panel 542 allows for increased visibility. The material is hard/rigid execution (e.g., polycarbonate/tempered glass, etc.). Alternatively, soft execution of the panel 542 (e.g., PVC soft glass, etc.).

FIGS. 49A-B depicts the exemplary door panel attachment feature. The door structure 544 is illustrated without the attached door panel 542 in FIG. 49A. As can be seen in FIGS. 49A-B, the lip feature 546 is not depicted as formed with the door structure 544 (although it is understood that is could be as an alternative), and the lip feature 546 is formed of an inner ring 548 attached to the door structure surround 552. This inner ring 548 creates a mounting/sealing surface for the door panel 544 in the opening 550 of the door structure 544. The inner ring 548 is operably attached, e.g., bolted, welded, bonded, etc to the door structure 544. The panel attachment arrangement allows for multiple panel depths to the door surface, including flush and underflush.

It is understood that right side door assembly is a mirror image to the left side door assembly. It is further understood that the assembly is readily adaptable for a front side door assembly and for a rear side door assembly of the present invention, and that while one may be depicted—this present invention is not limited to either a front door or a rear door. The door panel (and side door assembly 540) are adaptable for any modular side door assembly and features, e.g., add-on accessories, accessory attachment methods, core door executions, door structure, steel metal structures, enclosure panels, enclosure panel materials, front side doors (right/left) assemblies, rear side doors (right/left) assemblies, door structure, door panels, removable panels, removable panel schemes, removable panel structures and variations, etc. and in any combinations thereof, depicted or described throughout this application.

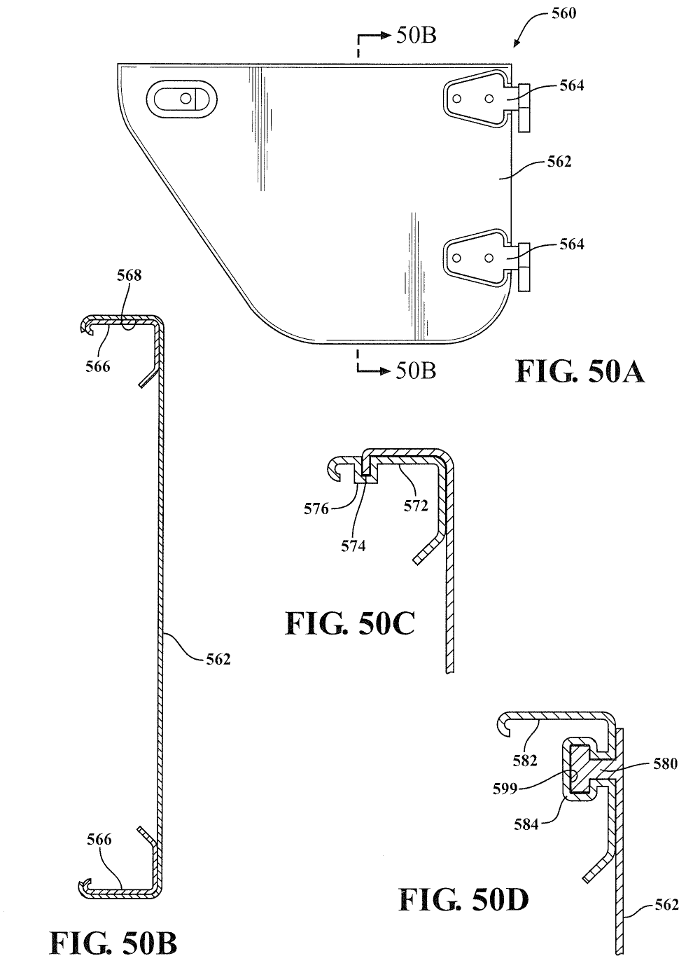

Referring now to FIGS. 50A-50D, there is depicted a full coverage enclosure panel, in accordance with an aspect of the present invention. A side door assembly 560 includes a door panel 562, which is depicted as a door enclosure panel. Hinges 546 are provided to operably connect to the door enclosure panel 562 to the vehicle. FIGS. 50B-D depict structures of attachment of the full coverage enclosure panel 562 to door structure 566. In FIG. 50B, the door panel 562 surrounds the door structure 566, e.g., by a snap on or slide on installation/removal, etc. The door panel 562 includes a channel 568 or any other suitable profile to install to the door structure 566 received within the channel portion 568. FIG. 50C depicts the door panel 562 engaging a corresponding feature in the door structure 572 to affix/align the panel 562 and door structure 572. The door structure 572 includes a channel 574 to receive an end 574 of the door panel 562. The door panels can be snap on or slid on for installation/removal. FIG. 50D depicts the door panel 562 including an attachment feature 580, e.g., “T”-shaped. The door structure 582 includes an engagement feature 584 with a shaped recess 586 to hold the attachment feature 580 (e.g., T-shaped slid into the recess 586 or channel and cannot back out of the opening laterally. The door panel 562 therefore engages features in the face of the door structure 582.

It is understood that right side door assembly is a mirror image to the left side door assembly. It is further understood that the assembly is readily adaptable for a front side door assembly and for a rear side door assembly of the present invention, and that while one may be depicted—this present invention is not limited to either a front door or a rear door. The door panel (and side door assembly 560) are adaptable for any modular side door assembly and features, e.g., add-on accessories, accessory attachment methods, core door executions, door structure, steel metal structures, enclosure panels, enclosure panel materials, front side doors (right/left) assemblies, rear side doors (right/left) assemblies, door structure, door panels, removable panels, removable panel schemes, removable panel structures and variations, etc. and in any combinations thereof, depicted or described throughout this application.

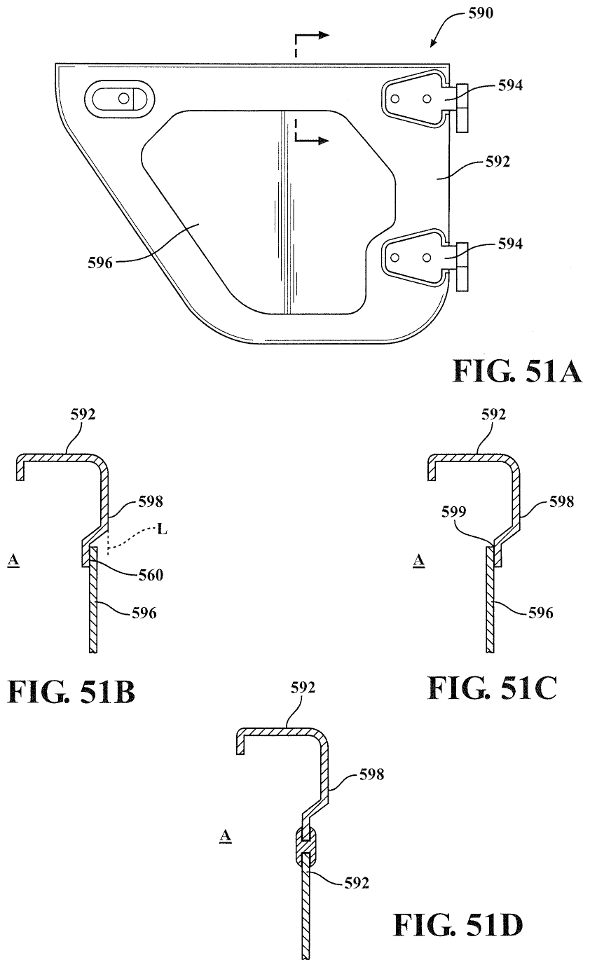

Referring now to FIGS. 51A-51D, there is depicted recessed panel mounting locations, in accordance with an aspect of the present invention. A side door assembly 590 includes door structure 592 with hinges 594 for connecting to the vehicle. FIG. 51A depicts a recessed outer mount. In particular, the door panel 596 is recessed below the outer surface 598 of the door structure 592 (depicted by line “L”) with respect to the interior cabin area (depicted as ‘A’). The door panel 596 is mounted to an outside surface 560 of the door structure 592. FIG. 51B depicts a recessed inner mount. In particular, the door panel 596 is recessed below the outer surface 598 of the door structure 592, but is mounted to an interior surface 599 of the door structure 592 with respect to the interior cabin area (depicted as ‘A’). FIG. 51D depicts a recessed even mount. The door panel 592 is recessed below the outer surface 598 of the door structure 592. The door panel 592 is mounted in-line with the door structure 592. At least one fastener mounts the door panel 592 to the door structure 592, preferably, at least one H-section extrusion fastener.

It is understood that right side door assembly is a mirror image to the left side door assembly. It is further understood that the assembly is readily adaptable for a front side door assembly and for a rear side door assembly of the present invention, and that while one may be depicted—this present invention is not limited to either a front door or a rear door. The door panel (and side door assembly 590) are adaptable for any modular side door assembly and features, e.g., add-on accessories, accessory attachment methods, core door executions, door structure, steel metal structures, enclosure panels, enclosure panel materials, front side doors (right/left) assemblies, rear side doors (right/left) assemblies, door structure, door panels, removable panels, removable panel schemes, removable panel structures and variations, etc. and in any combinations thereof, depicted or described throughout this application.

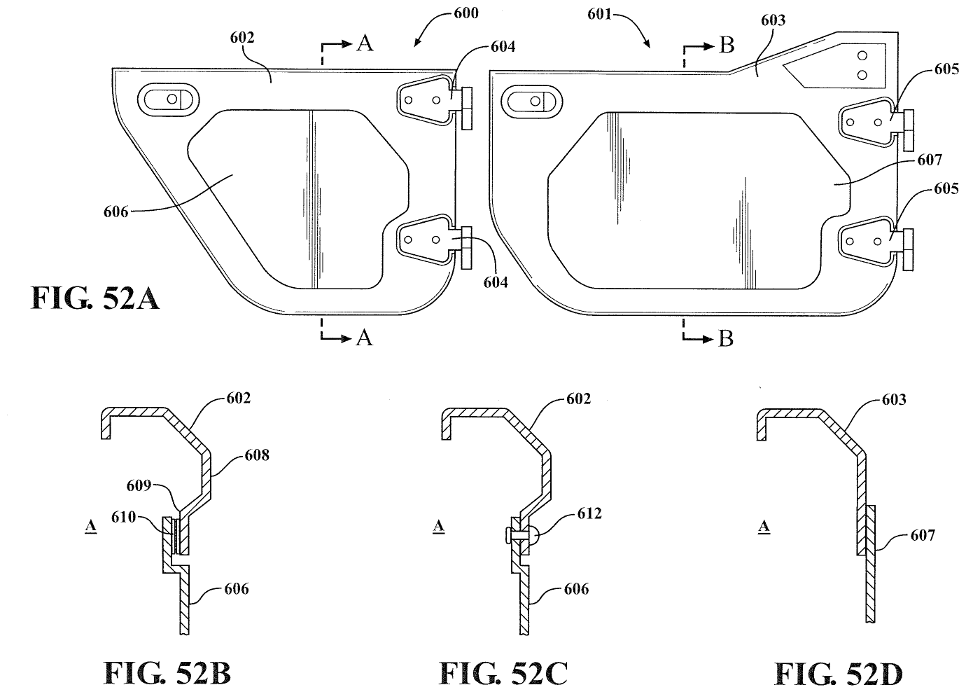

Referring now to FIGS. 52A-52E, there is depicted panel mounting variations, in accordance with an aspect of the present invention. Referring more particularly to FIGS. 52A-52C, a side door assembly 600 includes door structure 602 with hinges 604 for connecting to the vehicle. FIG. 52B depicts an interior mounted/flush door panel. FIG. 52B is taken along sections A-A of FIG. 52A. The door panel 606 is not mounted to an outer surface 608 of the door structure 602. The door panel 606 geometry allows for interior mounting to an interior surface 609 of the door structure 602 with respect to the interior cabin area (depicted as ‘A’), and the door panel 606 is flush to the door structure interface. The door panel 606 is affixed using at least one fastener 610. Preferably, the door panel 606 is affixed to the door structure 602 using at least one hook and loop fastener. Alternatively, the door panel is affixed by bonded/sealed interface, e.g., utilizing silicone, or other suitable materials, etc. FIG. 51C depicts the door panel 606 interior mounted and the door panel 606 flush. The door panel 606 is affixed using at least one mechanical fastener 612, preferably, a plurality of mechanical fasteners 612, e.g., nut & bolts, studs, door/studs on panel, any other suitable fastener, etc and combinations thereof. It is understood that the door, e.g., rear door, is adaptable in FIGS. 52A-52C to incorporate features of FIGS. 52D-52E. Referring more particularly to FIGS. 52D-52E, there is depicted a side door assembly 601, e.g., front door, including door structure 603 with hinges 605,605, for connecting to the vehicle. FIG. 52E depicts an exterior mounted/proud door panel. FIG. 52E is taken along sections B-B of FIG. 52D. The door panel 607 sits on top of the door structure 603, which allows for simple manufacturing process and simple installation/removal. Preferably, the door panel 607 is operably connected to the outer surface of the door structure 603.

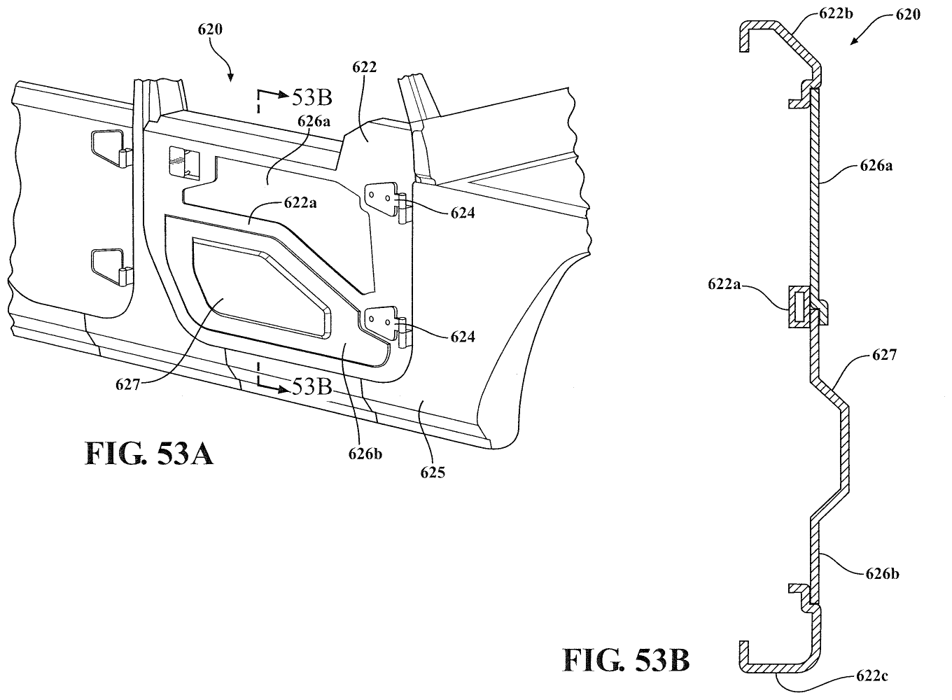

It is understood that right side door assembly is a mirror image to the left side door assembly. It is further understood that the assembly is readily adaptable for a front side door assembly and for a rear side door assembly of the present invention, and that while one may be depicted—this present invention is not limited to either a front door or a rear door. The door panels (and side door assemblies 600, 601) are adaptable for any modular side door assembly and features, e.g., add-on accessories, accessory attachment methods, core door executions, door structure, steel metal structures, enclosure panels, enclosure panel materials, front side doors (right/left) assemblies, rear side doors (right/left) assemblies, door structure, door panels, removable panels, removable panel schemes, removable panel structures and variations, etc. and in any combinations thereof, depicted or described throughout this application. Referring now to FIGS. 53A-53B, there is depicted a side door assembly 620 with multiple removable panels, in accordance with an aspect of the present invention. The side door assembly 620 includes door structure 622 with hinges 624 for connecting to the vehicle 625. A plurality of panels are provided. Preferably, at least two panels, a first panel 626a (e.g., an upper enclosure panel) and a second panel 626b (e.g., a lower enclosure panel). Each door panel 626a,626b is operably connected to the door structure 622 and preferably removable when desired. Preferably, there is an intermediate door structure 622a to which both door panels 626a,626b are operably connected. Each door panel 626a,626b is preferably connected to respective outer recessed door structure 622b,622c and to the intermediate door structure 622a. The first and second door panels 626a,626b may be stand alone, or can interconnect and work together (e.g., such as depicted in FIG. 53B). Thus, the door 620 is adaptable to allow the door panels 626a,626b to be used individually, or to use the first and second door panels 626a,626b together to provide a sealed solution (e.g., FIG. 53B. The materials can be the same or different. By way of example, the first door panel 626a could be formed of at least one material that is different to the second door panel 626b material(s). Various door panel profiles can be used, e.g., FIGS. 53A-53B depict an exemplary bump out 627.

It is understood that the assembly is adaptable for more or less than two removable panels.

It is understood that right side door assembly is a mirror image to the left side door assembly. It is further understood that the assembly is readily adaptable for a front side door assembly and for a rear side door assembly of the present invention, and that while one may be depicted—this present invention is not limited to either a front door or a rear door. The door panel and (and side door assembly 620) are adaptable for any modular side door assembly and features, e.g., add-on accessories, accessory attachment methods, core door executions, door structure, steel metal structures, enclosure panels, enclosure panel materials, front side doors (right/left) assemblies, rear side doors (right/left) assemblies, door structure, door panels, removable panels, removable panel schemes, removable panel structures and variations, etc. and in any combinations thereof, depicted or described throughout this application.

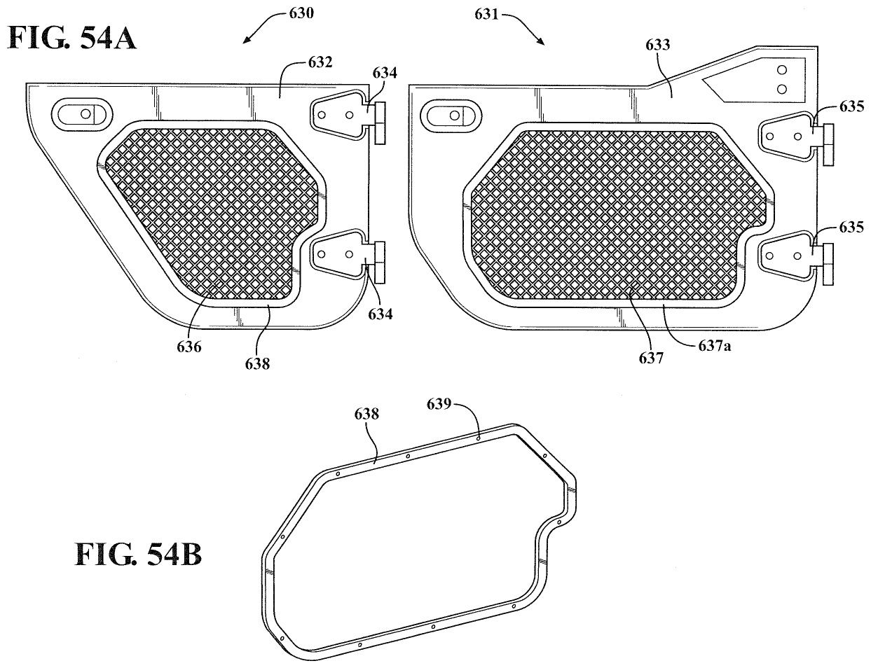

Referring now to FIGS. 54A-54C, there is depicted a side door assembly 630, e.g., rear door, with at least one door panel, in accordance with an aspect of the present invention. The side door assembly 630 includes door structure 632 with hinges 634 for connecting to the vehicle. The door panel 636 is made of a mesh, preferably, a rigid mesh. Alternatively, the mesh is a soft style mesh. The door panel 636 connected to the door structure 632. The door panel 636 is fixed or selectively removable from the door structure 632 when desired. The door panel 636 utilizes any predetermined mesh pattern. The door panel 636 includes a halo 638, preferably, a perimeter halo 638. The halo 638 finishes the edge of the mesh/door panel and allows for multiple attachment methods to be used to connect the door panel 636 to the door structure 632 (e.g., using a plurality of fasteners 639, etc). The halo 638 also provides additional structure to the door panel 636. Preferably, the door panel 636 is operably connected to an outer surface of the door structure 632, e.g., recessed, proud, etc. using the halo 638. Referring more particularly to FIG. 54C there is depicted a side door assembly 631, e.g., front door, including door structure 633 with hinges 635,635, for connecting to the vehicle. The door panel 637 is made of a mesh, as described previously. The door panel 637 is connected to the door structure 633 using a halo 637a, described previously.

It is understood that right side door assembly is a mirror image to the left side door assembly. It is further understood that the assembly is readily adaptable for a front side door assembly and for a rear side door assembly of the present invention, and that while one may be depicted—this present invention is not limited to either a front door or a rear door. The door panels (and side door assemblies 630,631) are adaptable for any modular side door assembly and features, e.g., add-on accessories, accessory attachment methods, core door executions, door structure, steel metal structures, enclosure panels, enclosure panel materials, front side doors (right/left) assemblies, rear side doors (right/left) assemblies, door structure, door panels, removable panels, removable panel schemes, removable panel structures and variations, etc. and in any combinations thereof, depicted or described throughout this application.

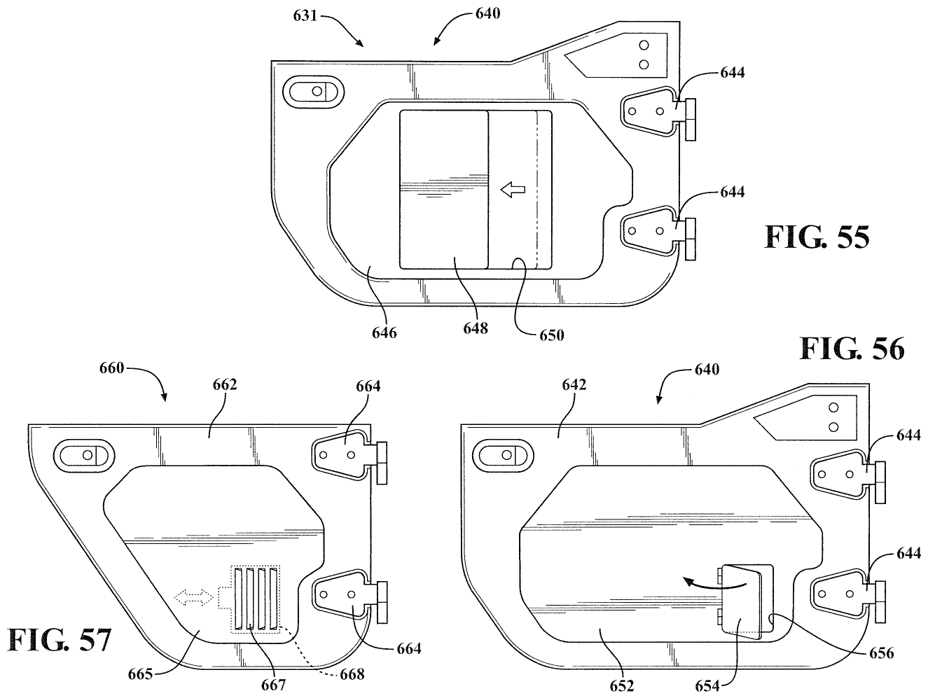

Referring now to FIGS. 55-56, there is depicted a side door assembly 640, e.g., front door, with multiple venting options, in accordance with an aspect of the present invention. The side door assembly 640 includes door structure 642 with hinges 644 for connecting to the vehicle. Referring more particularly to FIG. 55, a door panel 646 is mounted or otherwise connected to the door structure 642, e.g., to an outer surface or an inner surface of the door structure 642, in accordance with any of the teachings throughout the figures or description of the present application. Preferably, the door panel 646 is an inset panel operably connected to the door structure 642. The door panel 646 is removable from the door structure 642 when desired or is fixed. The door panel 646 includes at least one sliding window vent 648 slidable (as indicated by the arrow) to open/close an opening 650 formed in the door panel 646 to provide ventilation when desired. The sliding window vent 648 is captured in either a hard or soft surround of the door panel 646. The sliding window vent 648 can be polycarbonate, tempered glass or similar, or any other suitable window material, etc and any combinations thereof. Referring now more particularly to FIG. 56, there is provided at least one door panel 652 with at least one pivoting door vent 654. The door panel 652 is mounted or otherwise connected to the door structure 642, e.g., to an outer surface or an inner surface of the door structure 642, in accordance with any of the teachings throughout the figures or description of the present application. The door vent 654 is pivotable (as indicated by the arrow) to open/close an opening 656 formed in the door panel 652. The door opens allowing additional air into the cabin of the vehicle. The door panel 652 can be selectively removable when desired or fixed. The vent 654 feature can be part of the overall door panel 652 or utilized as an insert into a universal door panel with accommodations for multiple pieces.

Referring now to FIG. 57, there is depicted a side door assembly 660, e.g., rear door, with another venting option, in accordance with an aspect of the present invention. The side door assembly 660 includes door structure 662 with hinges 664 for connecting to the vehicle. A door panel 665 is mounted or otherwise connected to the door structure 662, e.g., to an outer surface or an inner surface of the door structure 662, in accordance with any of the teachings throughout the figures or description of the present application. Preferably, the door panel 665 is an inset panel operably connected to the door structure 662. The door panel 665 is removable from the door structure 662 when desired or is fixed. The door panel 665 includes at least one vent 667, e.g., a plurality of permanent slit vents 667 formed through the door panel 665. The vent is preferably a sliding vent. Permanent slit vents 667 are cut or otherwise formed into the door panel 665. An inner block 668 or baffle is actuated (e.g., slid a desired amount as indicated by the arrow) to allow/meter air flow into the cabin of the vehicle.

Referring to FIGS. 55-57, it is understood that right side door assembly is a mirror image to the left side door assembly. It is further understood that the assembly is readily adaptable for a front side door assembly and for a rear side door assembly of the present invention, and that while one may be depicted—this present invention is not limited to either a front door or a rear door. The doors panels (and side door assemblies 640,660) are adaptable for any modular side door assembly and features, e.g., add-on accessories, accessory attachment methods, core door executions, door structure, steel metal structures, enclosure panels, enclosure panel materials, front side doors (right/left) assemblies, rear side doors (right/left) assemblies, door structure, door panels, removable panels, removable panel schemes, removable panel structures and variations, etc. and in any combinations thereof, depicted or described throughout this application.

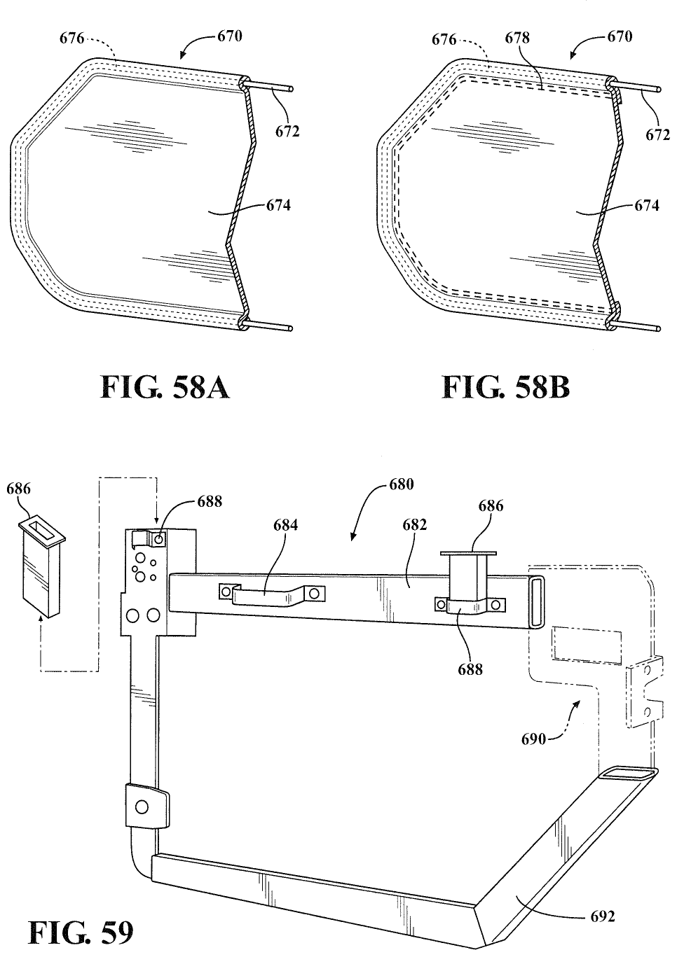

Referring now to FIGS. 58A-58B, there is depicted a door panel assembly 670 or filler to be operably connected to predetermined structure, e.g., door structure, in accordance with an aspect of the present invention. The door panel 670 includes at least one perimeter member 672 formed for tension and structure. The perimeter member 672 can be operably connected to at least one door panel 674 formed of predetermined material. The panel 674 material is sewn, bonded, welded, glued, riveted, formed or molded on or over the perimeter member 672. The panel 674 can be made from metal formed and welded to the perimeter member 672, or molded, formed or cured structural shape that attaches to the perimeter member 672. Preferably, a channel 676 or pocket is operably formed in the panel 674 contains the structural member 672 generally along the perimeter of the door panel 670. This channel 676 can be operably formed, e.g., molded, etc. FIG. 58B depicts the channel 676 formed by overlapping panel 674 material and sewing 678 a pocket to receive the structural member 672. The door panel 674 is mounted or otherwise connected to structure, e.g., door structure, e.g., in accordance with any of the teachings throughout the figures or description of the present application, within an opening formed in the door structure, etc.

It is understood that right side door assembly is a mirror image to the left side door assembly. It is further understood that the assembly is readily adaptable for a front side door assembly and for a rear side door assembly of the present invention, and that while one may be depicted—this present invention is not limited to either a front door or a rear door. The door panels (and side door assembly) are adaptable for any modular side door assembly and features, e.g., add-on accessories, accessory attachment methods, core door executions, door structure, steel metal structures, enclosure panels, enclosure panel materials, front side doors (right/left) assemblies, rear side doors (right/left) assemblies, door structure, door panels, removable panels, removable panel schemes, removable panel structures and variations, etc. and in any combinations thereof, depicted or described throughout this application.

Referring now to FIG. 59, there is depicted a side door assembly structure 680, e.g., front door, in accordance with an aspect of the present invention. The side door assembly 680 includes door structure 682 and operably connects to the vehicle. Optionally, a least one pull handle 684 is provided, e.g., at least one exterior handle mounting plate incorporating a pull handle 684 is connected to the door structure 682. At least two attachment members 688 are connected to the door structure 682 to each receive a respective upper sleeve 686 for selectively receiving an upper window attachment feature, respectively. The attachment members 688 are a bracket or brace to hold the upper sleeves 686. A latch mount 690 is provided, which is a plate or formed detail. The side door assembly structure 680 incorporates formed or stamped metal mounting features. The structure 680 can be formed from a multi-part weldment or other process. The structure 690 includes at least one tube structure 620, preferably, a mitered tube and/or plate-weldment construction.

It is understood that right side door assembly is a mirror image to the left side door assembly. It is further understood that the assembly is readily adaptable for a front side door assembly and for a rear side door assembly of the present invention, and that while one may be depicted—this present invention is not limited to either a front door or a rear door. The door (and side door assembly 680) are adaptable for any modular side door assembly and features, e.g., add-on accessories, accessory attachment methods, core door executions, door structure, steel metal structures, enclosure panels, enclosure panel materials, front side doors (right/left) assemblies, rear side doors (right/left) assemblies, door structure, door panels, removable panels, removable panel schemes, removable panel structures and variations, etc. and in any combinations thereof, depicted or described throughout this application.

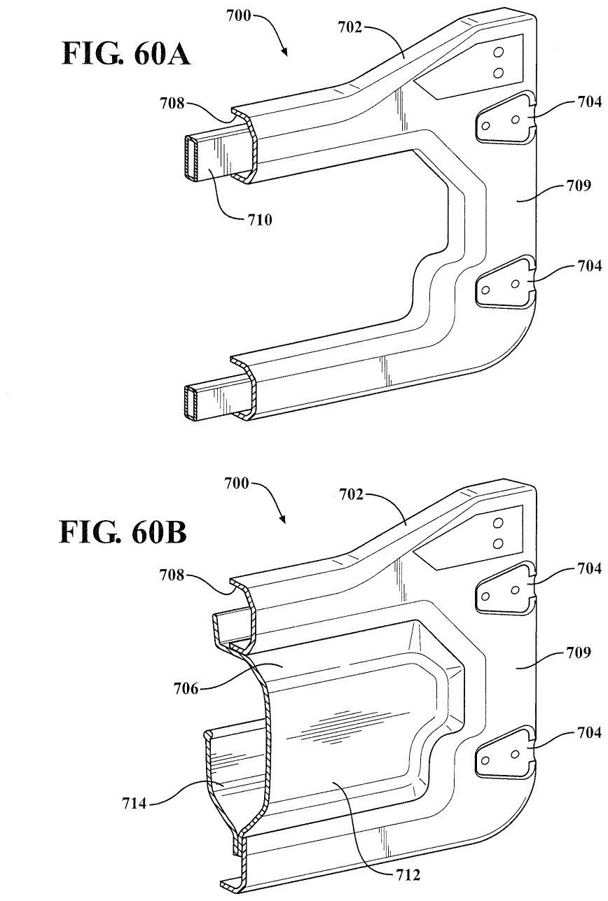

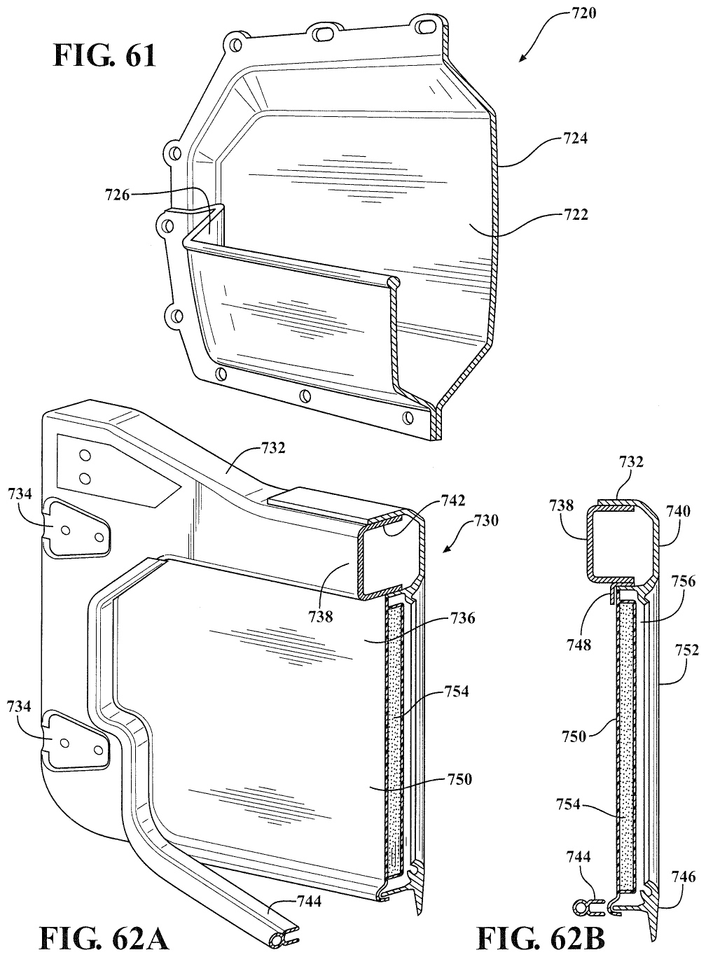

Referring now to FIGS. 60A-60B, there is depicted a cross section taken through a side door assembly 700, e.g., front door, in accordance with an aspect of the present invention. The side door assembly 700 includes door structure 702 with hinge attachments 704 for hinges to connect to the vehicle. A door panel (e.g., 706 in FIG. 61, mesh, or any other panel throughout the drawings or description of the present application) can be operably mounted to the door structure 702. The door structure 702 incorporates a shell 708, e.g., fiberglass shell, which includes a fiberglass Class “A” 709 or “show surface”. At least one structural member 710 is provided, preferably, a tube structure. The structural member 710 is preferably a metal structure for strength and reinforcement of the door assembly 700. The formed plastic or molded fiberglass shell 708 of the door structure 702 goes over the metallic structure 710. Referring now to FIG. 60B, the door panel 706 is operably connected to the door structure 702, e.g., shell 708, and preferably includes a bump-out 712 storage 714 and access system. The door panel 706 is preferably thermoformed or rotational molded.

It is understood that right side door assembly is a mirror image to the left side door assembly. It is further understood that the assembly is readily adaptable for a front side door assembly and for a rear side door assembly of the present invention, and that while one may be depicted—this present invention is not limited to either a front door or a rear door. The door (and side door assembly 700) are adaptable for any modular side door assembly and features, e.g., add-on accessories, accessory attachment methods, core door executions, door structure, steel metal structures, enclosure panels, enclosure panel materials, front side doors (right/left) assemblies, rear side doors (right/left) assemblies, door structure, door panels, removable panels, removable panel schemes, removable panel structures and variations, etc. and in any combinations thereof, depicted or described throughout this application.

Referring now to FIG. 61, there is depicted a cross section taken through a door panel 720 for a side door assembly, e.g., front door, in accordance with an aspect of the present invention. The door panel 720 includes at least one bump-out that creates room for at least one storage space. The bump-out 722 is in the direction of the exterior of the door Class “A” surface 724. At least one storage compartment 726 is provided (interior side of the door) for storage space or a bin within the cabin of the vehicle. The storage compartment 726 can be mesh, fabric, semi-rigid, solid material, any other suitable materials(s), etc. and any combinations thereof. The door panel 722 is illustrated with apertures for fastening the door panel 722 to door structure, however, it is understood that the door panel 722 is adaptable for attachment in accordance with any aspect of the present invention.

It is understood that right side door assembly is a mirror image to the left side door assembly. It is further understood that the assembly is readily adaptable for a front side door assembly and for a rear side door assembly of the present invention, and that while one may be depicted—this present invention is not limited to either a front door or a rear door. The door panel (and side door assembly 720) are adaptable for any modular side door assembly and features, e.g., add-on accessories, accessory attachment methods, core door executions, door structure, steel metal structures, enclosure panels, enclosure panel materials, front side doors (right/left) assemblies, rear side doors (right/left) assemblies, door structure, door panels, removable panels, removable panel schemes, removable panel structures and variations, etc. and in any combinations thereof, depicted or described throughout this application.

Referring now to FIGS. 62A-62B, there is depicted a cross section taken through a door panel assembly 730, e.g., front door, in accordance with an aspect of the present invention. The side door assembly 730 includes door structure 732 with hinge attachments 734 for hinges to connect to the vehicle. A door panel 736 operably connects to the door structure 732. The door structure 732 incorporates an upper cover 738. The upper cover 738 is attached to the door structure upper by at least one fastener 748, e.g., P.S.A. or at least one hoop/loop or mechanical fastener or any other suitable fastener. Optionally, an inner space 742 formed by the upper cover 736 and outer surface 740 of the door structure 732 can include an attachment location or for running door panel 736 attachment through the door structure 732. Optionally, a gasket tensioned system 744 is operably connected to the door panel 736 (illustrated pulled away to see the gasket). The gasket presses the door panel 736 to an attachment structure 746, e.g., structure or cast part, for further tensioning. The door panel 736 includes a plurality of layered parts. The door panel 736 preferably includes at least an inner surface 750, exterior surface 752 and an intermediate section 754 including sound dampening and/or thermal insulation. Preferably, the exterior surface 752 is a panel or at least one functional filler accessory. Preferably, the inner surface 750 is a panel that is connected to the door structure 732, e.g., via at least the gasket structure 744. Preferably, an air gap 756 or filler space is provided in the door panel 736, e.g., preferably generally between the intermediate section 754 with the sound dampening and/or thermal insulation and the exterior panel 752.

It is understood that right side door assembly is a mirror image to the left side door assembly. It is further understood that the assembly is readily adaptable for a front side door assembly and for a rear side door assembly of the present invention, and that while one may be depicted—this present invention is not limited to either a front door or a rear door. The door panel (and side door assembly 730) are adaptable for any modular side door assembly and features, e.g., add-on accessories, accessory attachment methods, core door executions, door structure, steel metal structures, enclosure panels, enclosure panel materials, front side doors (right/left) assemblies, rear side doors (right/left) assemblies, door structure, door panels, removable panels, removable panel schemes, removable panel structures and variations, etc. and in any combinations thereof, depicted or described throughout this application.

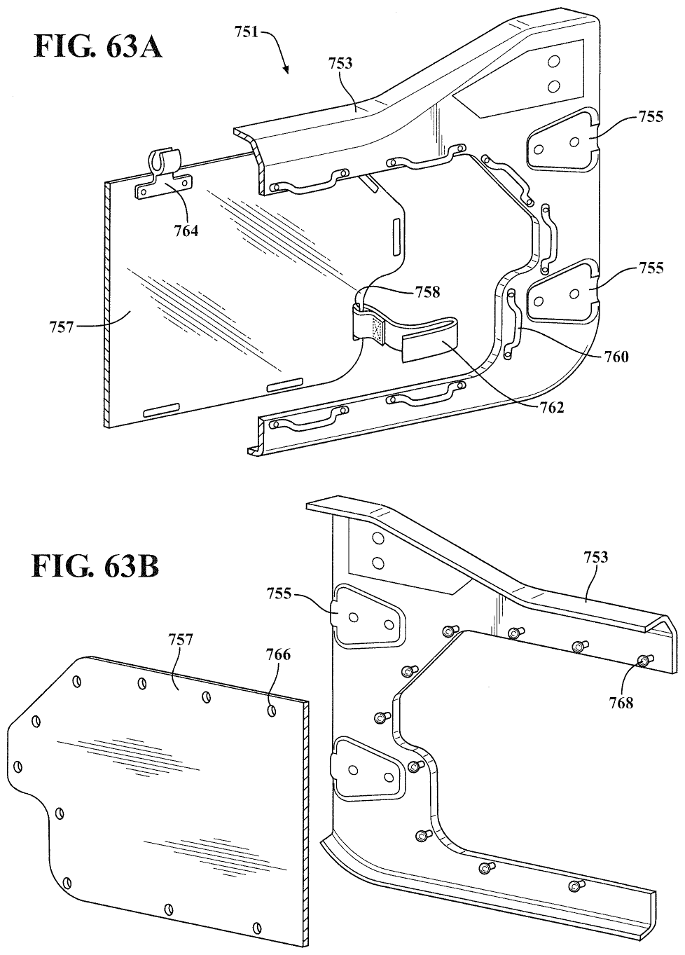

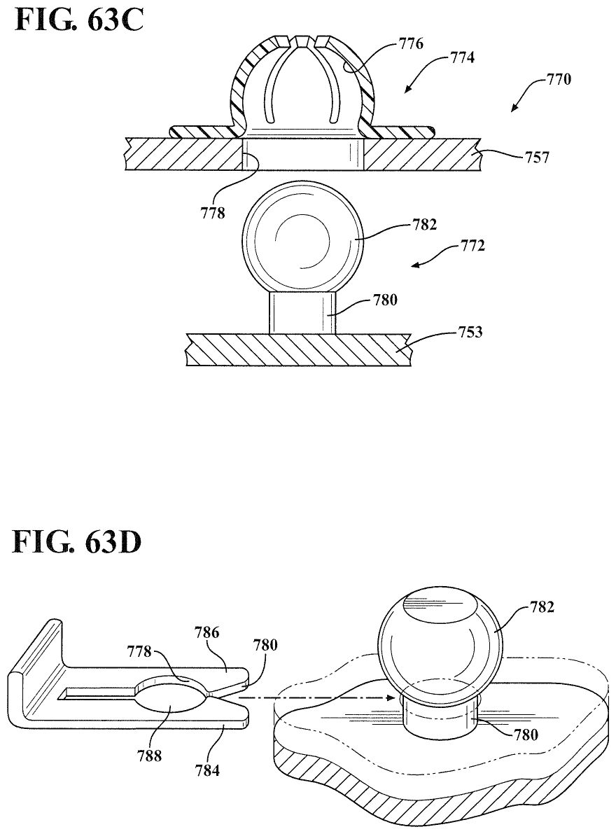

Referring now to FIGS. 63A-63D to there is depicted multiple options for panel attachments to frame or structure, in accordance with aspects of the present invention. FIG. 63A depicts a cross section of a side door assembly 751 including a door structure 753 with hinge points 755 for attachment to a vehicle. A door panel 757 is operably connected to the door structure 753. One exemplary attachment method incorporates at least one strap. Preferably, the door panel 757 has a plurality of apertures 758 that correspond with a plurality of hooks or brackets 760 mounted to the door structure (the panel 757 is illustrated slid away from the door structure 753 to see the attachment parts. A strap 762 is connected through each aperture 758 and looped around the corresponding bracket 760 for attachment of the door panel 757 to the door structure 753. Preferably, the strap 762 has a hook and loop closure. Also illustrated in FIG. 63A is an exemplary attachment 764 connected to the door panel 757. At least one attachment 764, e.g., a C-clip, is connected to the door panel 756 that is a push-on attachment to operably connect to corresponding door structure 753. Referring now to FIG. 63B, there is depicted a plurality of apertures 766 formed in the door panel 757 for attachment to the door structure 753 with a plurality of fasteners 772, e.g., ball-stud fasteners, etc. Referring now to FIG. 63C, there is depicted an exemplary fastener for attachment of the door panel 757 to the door structure 753. A fastener arrangement is depicted generally at 770, including a ball-stud fastener 772 and socket member 774. The socket member 774 includes a ball socket 776 operably connected to the door panel 757 adjacent the aperture 778 formed in the door panel 756. A stud 780 is operably connected to the door structure 753 and to a ball 780 portion of the ball-stud fastener 772. The ball 782 is operably received (e.g., slid) through the aperture 778 and selectively held in the socket 776. Most preferably, a plurality of captive or loose slide clips are provided (e.g., FIG. 63D). Referring now to FIG. 63D, an exemplary aperture 778 with a slot entry point 780 for the stud 780 is depicted. Preferably, the hole 778 is a keyhole. Most preferably, the aperture 778 includes detent legs 784,786 that open as the stud 780 of the fastener 772 is pushed through to a larger diameter portion 788 that retains the stud.

It is understood that right side door assembly is a mirror image to the left side door assembly. It is further understood that the assembly is readily adaptable for a front side door assembly and for a rear side door assembly of the present invention, and that while one may be depicted—this present invention is not limited to either a front door or a rear door. The door panel (and side door assembly 750) are adaptable for any modular side door assembly and features, e.g., add-on accessories, accessory attachment methods, core door executions, door structure, steel metal structures, enclosure panels, enclosure panel materials, front side doors (right/left) assemblies, rear side doors (right/left) assemblies, door structure, door panels, removable panels, removable panel schemes, removable panel structures and variations, etc. and in any combinations thereof, depicted or described throughout this application.

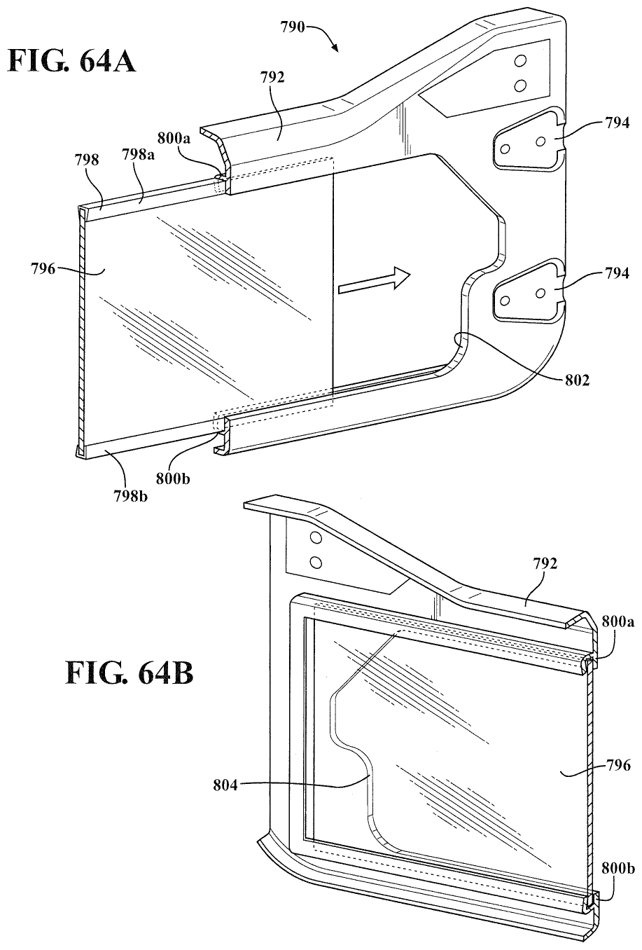

Referring now to FIGS. 64A-64B to there is depicted a slide in place panel attachment to frame or structure, in accordance with an aspect of the present invention. FIGS. 64A-B depict a cross section of a side door assembly 790 including a door structure 792 with hinge points 794 for attachment to a vehicle. A door panel 796 is operably connected to the door structure 792. At least one glide-gasket 798 is provided, preferable, at least two glide-gaskets 798, a first glide-gasket 798a (e.g., upper glide-gasket) and a second glide-gasket 798b (e.g., lower glide-gasket). At least one channel is provided in the door structure 792 to receive the at least one glide-gasket. Preferably, a first channel 800a (e.g., upper channel) receives the first glide gasket 798a and a second channel 800b (e.g., lower channel) receives the second gasket 798b. The door panel 796 is slid to open/close the opening 802 in the door structure 792. Preferably, the door panel 796 is operably removable from the door structure 792 when a more open air feel is desired. Press-in or PSA gaskets 804 on housing front and rear can be incorporated. Preferably, the door panel 796 is slid in from the end.

It is understood that right side door assembly is a mirror image to the left side door assembly. It is further understood that the assembly is readily adaptable for a front side door assembly and for a rear side door assembly of the present invention, and that while one may be depicted—this present invention is not limited to either a front door or a rear door. The door panel (and side door assembly 790) are adaptable for any modular side door assembly and features, e.g., add-on accessories, accessory attachment methods, core door executions, door structure, steel metal structures, enclosure panels, enclosure panel materials, front side doors (right/left) assemblies, rear side doors (right/left) assemblies, door structure, door panels, removable panels, removable panel schemes, removable panel structures and variations, etc. and in any combinations thereof, depicted or described throughout this application.

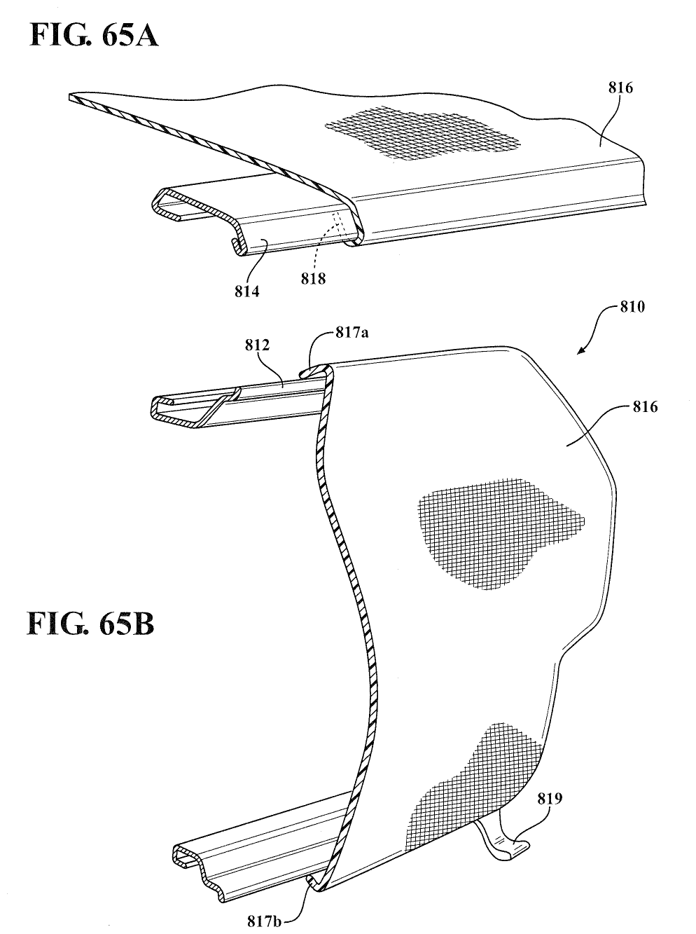

Referring now to FIGS. 65A-65B to there is depicted a cover, e.g., kayak cover style, in accordance with an aspect of the present invention. FIGS. 65A-B depict a cross section of a side door assembly 810 including a door structure 812 with hinge points for attachment to a vehicle. A door panel 816 is operably connected to the door structure 814. The door structure 812 includes a J-rail 814 on top of the door edge for a duster cover or tonneau attachment, preferably, a soft goods cover, most preferably, a fabric cover 816. Most preferably, the system is an over center tension with a retainer 818 of the door panel 816. Referring now to FIG. 65B, a J-rail style attachment for the cover is illustrated for attaching the cover toward the ends 817a,817b to respective structure. There are predetermined flexible cover options, e.g., molded, fabric with elastic cord, fabric with rubber webbing, color silicone mold rubber. At least one pull tab 819 is provided to remove/stretch/install the cover down over the J-rail attachment.

It is understood that right side door assembly is a mirror image to the left side door assembly. It is further understood that the assembly is readily adaptable for a front side door assembly and for a rear side door assembly of the present invention, and that while one may be depicted—this present invention is not limited to either a front door or a rear door. The door panel (and side door assembly 810) are adaptable for any modular side door assembly and features, e.g., add-on accessories, accessory attachment methods, core door executions, door structure, steel metal structures, enclosure panels, enclosure panel materials, front side doors (right/left) assemblies, rear side doors (right/left) assemblies, door structure, door panels, removable panels, removable panel schemes, removable panel structures and variations, etc. and in any combinations thereof, depicted or described throughout this application.

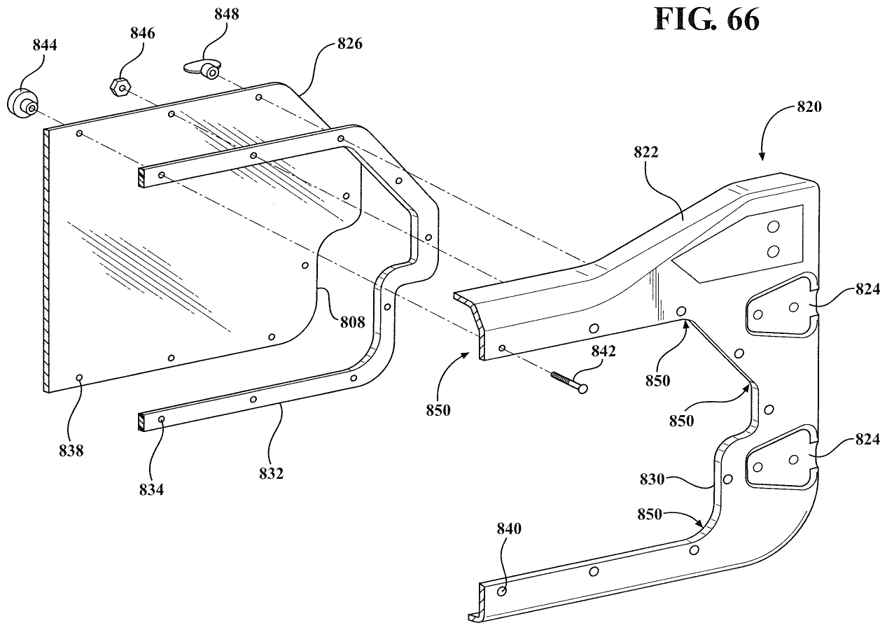

Referring now to FIG. 66, there is depicted attachments, in accordance with aspects of the present invention. An exploded view of a side door panel assembly 820 cross section is illustrated. The assembly 820 includes door structure 822 with hinge attachments 824 for connecting to a vehicle. A door panel 826 is operably connected to the door structure 822 with a plurality of fasteners. At least one edge 828 of the door panel 826 is cut for the opening 830 of the door structure 822. A gasket 832 is a die-cut or formed-in-place gasket and includes a plurality of apertures 834. The door panel 826 includes a plurality of corresponding apertures 838. The door structure 822 includes a plurality of apertures 840 aligning with the gasket apertures 834 and door panel apertures 838, respectively. The apertures 823,838,850 are in alignment and the plurality of fasteners 842 fit through the aligned apertures, respectively. The plurality of fasteners 842 are press-in studs or weld-in studs or bolts. Further attachments features for the plurality of fasteners 842 ensure that the parts cannot back off the fasteners 842 when undesired. The attachment features are hand knobs 844, nuts 846, wing T-nut 848, or any other suitable fastener. In addition, a plurality of kink returns, indicated generally at 850, for strength are incorporated with the door structure 822.

It is understood that right side door assembly is a mirror image to the left side door assembly. It is further understood that the assembly is readily adaptable for a front side door assembly and for a rear side door assembly of the present invention, and that while one may be depicted—this present invention is not limited to either a front door or a rear door. The door panel (and side door assembly 820) are adaptable for any modular side door assembly and features, e.g., add-on accessories, accessory attachment methods, core door executions, door structure, steel metal structures, enclosure panels, enclosure panel materials, front side doors (right/left) assemblies, rear side doors (right/left) assemblies, door structure, door panels, removable panels, removable panel schemes, removable panel structures and variations, etc. and in any combinations thereof, depicted or described throughout this application.

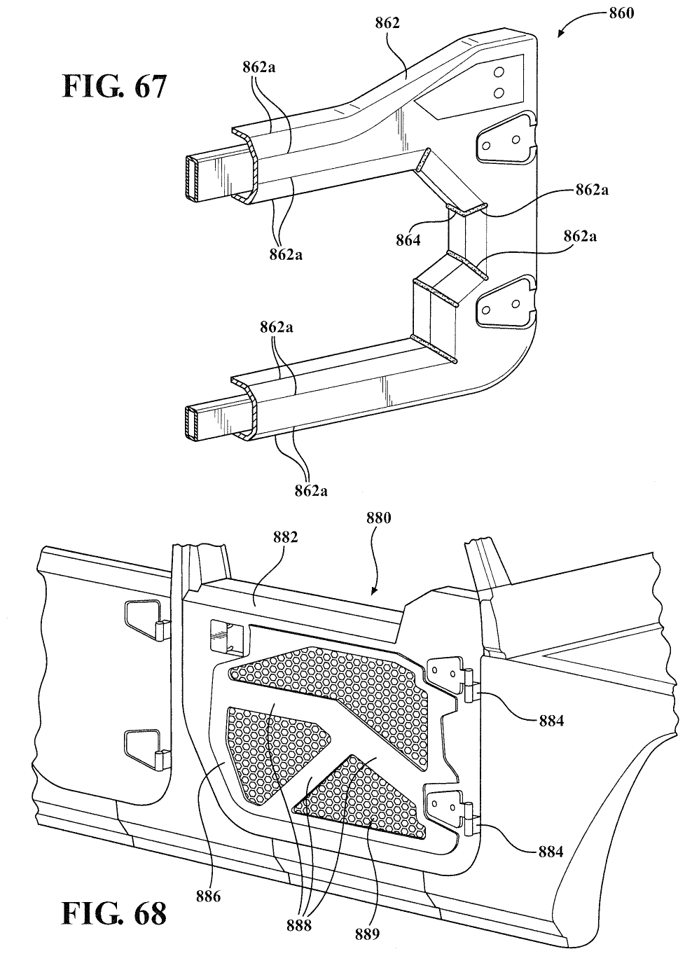

Referring now to FIG. 67, there is depicted a door structure assembly 860 with a door structure 862 including a plurality of welds 864. The door structure 862 is laser, plasma, CNC'd sheet stock construction and bent in a press break. A plurality of kink bend lines 862a are formed throughout the door structure 862 for strength. More or less welds 864 and kink bend lines 862a are contemplated depending on the application without departure from the scope of the present invention.

It is understood that right side door assembly is a mirror image to the left side door assembly. It is further understood that the assembly is readily adaptable for a front side door assembly and for a rear side door assembly of the present invention, and that while one may be depicted—this present invention is not limited to either a front door or a rear door. The door panel (and side door assembly 860) are adaptable for any modular side door assembly and features, e.g., add-on accessories, accessory attachment methods, core door executions, door structure, steel metal structures, enclosure panels, enclosure panel materials, front side doors (right/left) assemblies, rear side doors (right/left) assemblies, door structure, door panels, removable panels, removable panel schemes, removable panel structures and variations, etc. and in any combinations thereof, depicted or described throughout this application.

Referring now to FIG. 68, there is depicted a side door assembly 880 with a door structure 882 hinged 884 to a vehicle 886, e.g., SUV, power sports/SXS/UTV vehicles, etc. A door panel 886 includes intermediate webbing structure 888 and a mesh 889 coupled to the door panel 886, e.g., metal mesh, rigid mech, semi-rigid mesh, soft goods, honeycomb, etc. The door panel 886 is connected to the door structure 882.

It is understood that right side door assembly is a mirror image to the left side door assembly. It is further understood that the assembly is readily adaptable for a front side door assembly and for a rear side door assembly of the present invention, and that while one may be depicted—this present invention is not limited to either a front door or a rear door. The door panels (and side door assembly) are adaptable for any modular side door assembly and features, e.g., add-on accessories, accessory attachment methods, core door executions, door structure, steel metal structures, enclosure panels, enclosure panel materials, front side doors (right/left) assemblies, rear side doors (right/left) assemblies, door structure, door panels, removable panels, removable panel schemes, removable panel structures and variations, etc. and in any combinations thereof, depicted or described throughout this application.

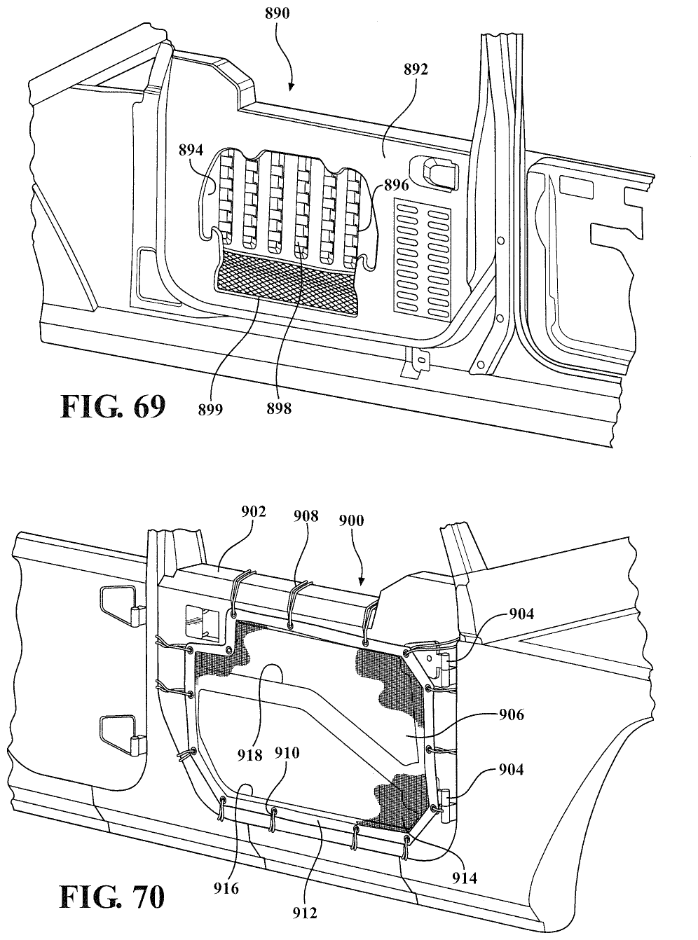

Referring now to FIG. 69, there is depicted a side door assembly 890 with a door structure 892 hinged to a vehicle, e.g., SUV, power sports/SXS/UTV vehicles, etc. The door structure 892 is provided with at least one opening 894. A door panel 886 incorporates a webbing 898 viewable through the opening 894 and is operably connected to the door structure 882. At least one net 899 is also connected to the door structure 892 and is accessible via the opening 894 for storage.

It is understood that right side door assembly is a mirror image to the left side door assembly. It is further understood that the assembly is readily adaptable for a front side door assembly and for a rear side door assembly of the present invention, and that while one may be depicted—this present invention is not limited to either a front door or a rear door. The door panels (and side door assembly) are adaptable for any modular side door assembly and features, e.g., add-on accessories, accessory attachment methods, core door executions, door structure, steel metal structures, enclosure panels, enclosure panel materials, front side doors (right/left) assemblies, rear side doors (right/left) assemblies, door structure, door panels, removable panels, removable panel schemes, removable panel structures and variations, etc. and in any combinations thereof, depicted or described throughout this application.

Referring now to FIG. 70, there is depicted a side door assembly 900 with a door structure 902 hinged 904 to a vehicle, e.g., SUV, power sports/SXS/UTV vehicles, etc. At least one door panel 906 is connected to the door structure 902 by a plurality of fasteners 908, e.g., bungee cords through a plurality of apertures 910 on a perimeter grommet 912. The door panel incorporates a fine netting 914, e.g., mosquito net type overlay, to close out openings 916, 918 of the door assembly 900.

It is understood that right side door assembly is a mirror image to the left side door assembly. It is further understood that the assembly is readily adaptable for a front side door assembly and for a rear side door assembly of the present invention, and that while one may be depicted—this present invention is not limited to either a front door or a rear door. The door panels (and side door assembly) are adaptable for any modular side door assembly and features, e.g., add-on accessories, accessory attachment methods, core door executions, door structure, steel metal structures, enclosure panels, enclosure panel materials, front side doors (right/left) assemblies, rear side doors (right/left) assemblies, door structure, door panels, removable panels, removable panel schemes, removable panel structures and variations, etc. and in any combinations thereof, depicted or described throughout this application.

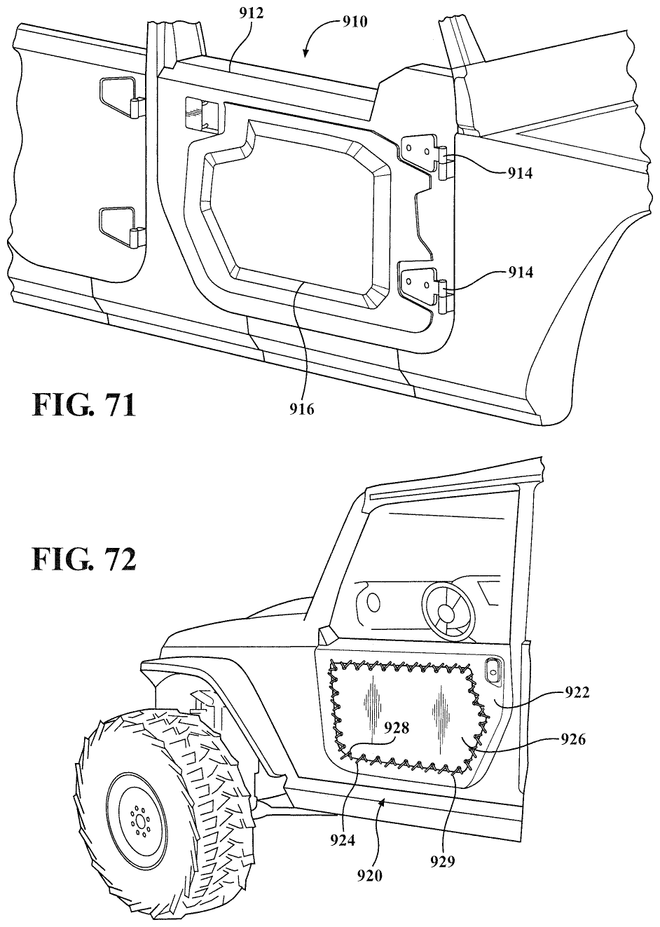

Referring now to FIG. 71, there is depicted a side door assembly 910 with a door structure 912 hinged 914 to a vehicle, e.g., SUV, power sports/SXS/UTV vehicles, etc., according to an aspect of the present invention. At least one door panel 916 is operably connected to the door structure 912. The door panel 916 is preferably is a different material and/or color (e.g., mold-in color, painted, flame treated, etc red, white, blue, graphics, etc.) from the door structure 912 surrounding the door panel 912. The door panel 916 includes at least one bump-out on the outer Class “A” show surface of the assembly 910.

It is understood that right side door assembly is a mirror image to the left side door assembly. It is further understood that the assembly is readily adaptable for a front side door assembly and for a rear side door assembly of the present invention, and that while one may be depicted—this present invention is not limited to either a front door or a rear door. The door panels (and side door assembly) are adaptable for any modular side door assembly and features, e.g., add-on accessories, accessory attachment methods, core door executions, door structure, steel metal structures, enclosure panels, enclosure panel materials, front side doors (right/left) assemblies, rear side doors (right/left) assemblies, door structure, door panels, removable panels, removable panel schemes, removable panel structures and variations, etc. and in any combinations thereof, depicted or described throughout this application.

Referring now to FIG. 72, there is depicted a side door assembly 922 with a door structure 922 hinged to a vehicle, e.g., SUV, power sports/SXS/UTV vehicles, etc. At least one door panel 926 is connected to the door structure 922 by a plurality of fasteners 924, e.g., tie-outs, straps, bungee cords etc, extending through a plurality of apertures 928 formed through the door panel 926 and a plurality of apertures 929 formed in the door structure 922.

It is understood that right side door assembly is a mirror image to the left side door assembly. It is further understood that the assembly is readily adaptable for a front side door assembly and for a rear side door assembly of the present invention, and that while one may be depicted—this present invention is not limited to either a front door or a rear door. The door panels (and side door assembly) are adaptable for any modular side door assembly and features, e.g., add-on accessories, accessory attachment methods, core door executions, door structure, steel metal structures, enclosure panels, enclosure panel materials, front side doors (right/left) assemblies, rear side doors (right/left) assemblies, door structure, door panels, removable panels, removable panel schemes, removable panel structures and variations, etc. and in any combinations thereof, depicted or described throughout this application.

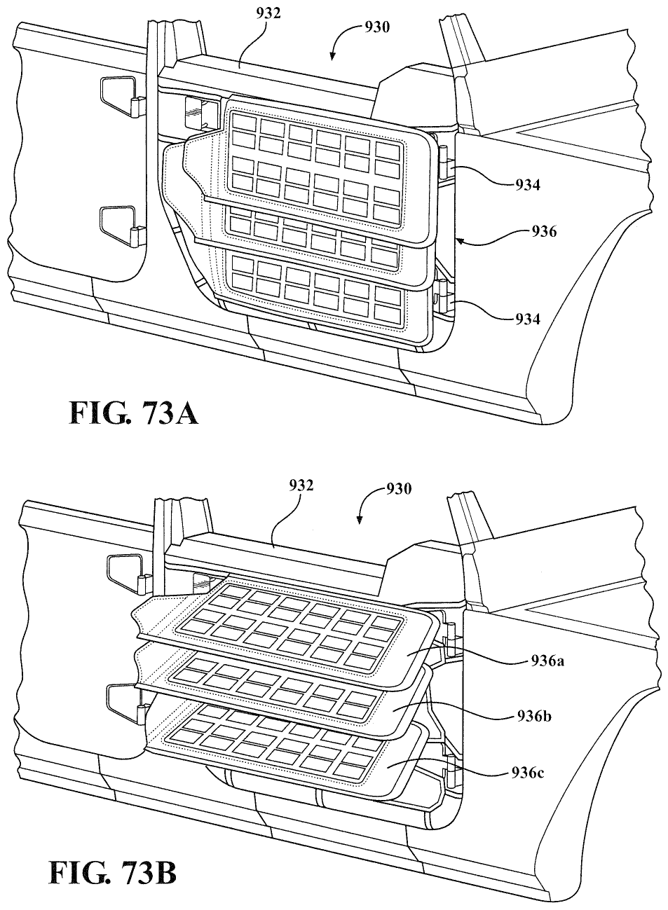

Referring now to FIGS. 73A-73B, there is depicted a side door assembly 930 with a door structure 932 hinged 934 to a vehicle, e.g., SUV, power sports/SXS/UTV vehicles, etc., according to an aspect of the present invention. At least one door panel 936 is operably connected to the door structure 932. The door panel 936 includes at least one rotatable panel 936a, preferably, a plurality of rotatable panels 936a. Depicted is at least three rotatable panels 936a, 936b, 936c operably rotatably mounted for rotating between a closed position (FIG. 73A) and at least on open position (73B) when air flow into the cabin is desired. The rotatable panels 936 are preferably flaps, e.g., semi-rigid or rigid flaps. According to an aspect of the present invention, each panel 936a-c can rotate together or individually as desired.

It is understood that right side door assembly is a mirror image to the left side door assembly. It is further understood that the assembly is readily adaptable for a front side door assembly and for a rear side door assembly of the present invention, and that while one may be depicted—this present invention is not limited to either a front door or a rear door. The door panels (and side door assembly) are adaptable for any modular side door assembly and features, e.g., add-on accessories, accessory attachment methods, core door executions, door structure, steel metal structures, enclosure panels, enclosure panel materials, front side doors (right/left) assemblies, rear side doors (right/left) assemblies, door structure, door panels, removable panels, removable panel schemes, removable panel structures and variations, etc. and in any combinations thereof, depicted or described throughout this application.

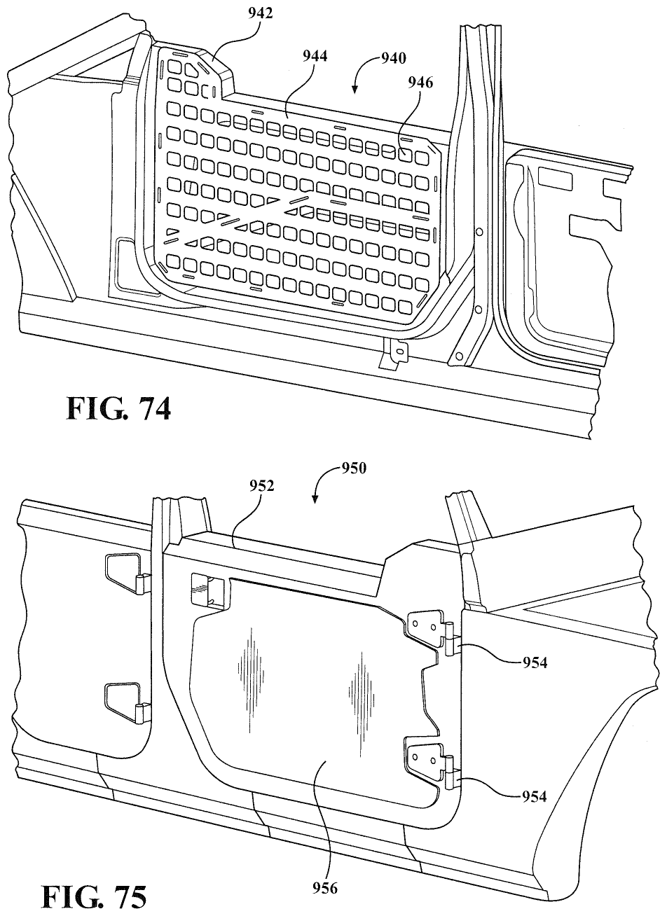

Referring now to FIG. 74, there is depicted a side door assembly 940 with a door structure 942 hinged to a vehicle, e.g., SUV, power sports/SXS/UTV vehicles, etc., according to an aspect of the present invention. A door panel 944 is operably connected to an outer surface of the door structure 942. The door panel 944 includes a plurality of apertures 946 for air flow into the vehicle cabin. Preferably, the door panel 944 is rigid or semi-rigid material.

It is understood that right side door assembly is a mirror image to the left side door assembly. It is further understood that the assembly is readily adaptable for a front side door assembly and for a rear side door assembly of the present invention, and that while one may be depicted—this present invention is not limited to either a front door or a rear door. The door panels (and side door assembly) are adaptable for any modular side door assembly and features, e.g., add-on accessories, accessory attachment methods, core door executions, door structure, steel metal structures, enclosure panels, enclosure panel materials, front side doors (right/left) assemblies, rear side doors (right/left) assemblies, door structure, door panels, removable panels, removable panel schemes, removable panel structures and variations, etc. and in any combinations thereof, depicted or described throughout this application.

Referring now to FIG. 75, there is depicted a side door assembly 950 with a door structure 952 hinged 954 to a vehicle, e.g., SUV, power sports/SXS/UTV vehicles, etc., according to an aspect of the present invention. At least one door panel 956 is operably connected to the door structure 952. The door panel 956 is preferably is a different material and/or color (e.g., mold-in color, painted, flame treated, etc red, white, blue, graphics, etc.) from the door structure 952 surrounding the door panel 952. The door panel 956 has no bump-out. The door panel 956 is has a generally flat outer Class “A” show surface.

It is understood that right side door assembly is a mirror image to the left side door assembly. It is further understood that the assembly is readily adaptable for a front side door assembly and for a rear side door assembly of the present invention, and that while one may be depicted—this present invention is not limited to either a front door or a rear door. The door panels (and side door assembly) are adaptable for any modular side door assembly and features, e.g., add-on accessories, accessory attachment methods, core door executions, door structure, steel metal structures, enclosure panels, enclosure panel materials, front side doors (right/left) assemblies, rear side doors (right/left) assemblies, door structure, door panels, removable panels, removable panel schemes, removable panel structures and variations, etc. and in any combinations thereof, depicted or described throughout this application.

Referring now to FIG. 76, there is depicted a side door assembly 960, e.g., front door, with a door structure 962 hinged to a vehicle, e.g., SUV, power sports/SXS/UTV vehicles, etc., according to an aspect of the present invention. At least one mesh cover 964 is operably connected to the door structure 962 adjacent an opening 966 in said door structure 962.

It is understood that right side door assembly is a mirror image to the left side door assembly. It is further understood that the assembly is readily adaptable for a front side door assembly and for a rear side door assembly of the present invention, and that while one may be depicted—this present invention is not limited to either a front door or a rear door. The door panels (and side door assembly) are adaptable for any modular side door assembly and features, e.g., add-on accessories, accessory attachment methods, core door executions, door structure, steel metal structures, enclosure panels, enclosure panel materials, front side doors (right/left) assemblies, rear side doors (right/left) assemblies, door structure, door panels, removable panels, removable panel schemes, removable panel structures and variations, etc. and in any combinations thereof, depicted or described throughout this application.

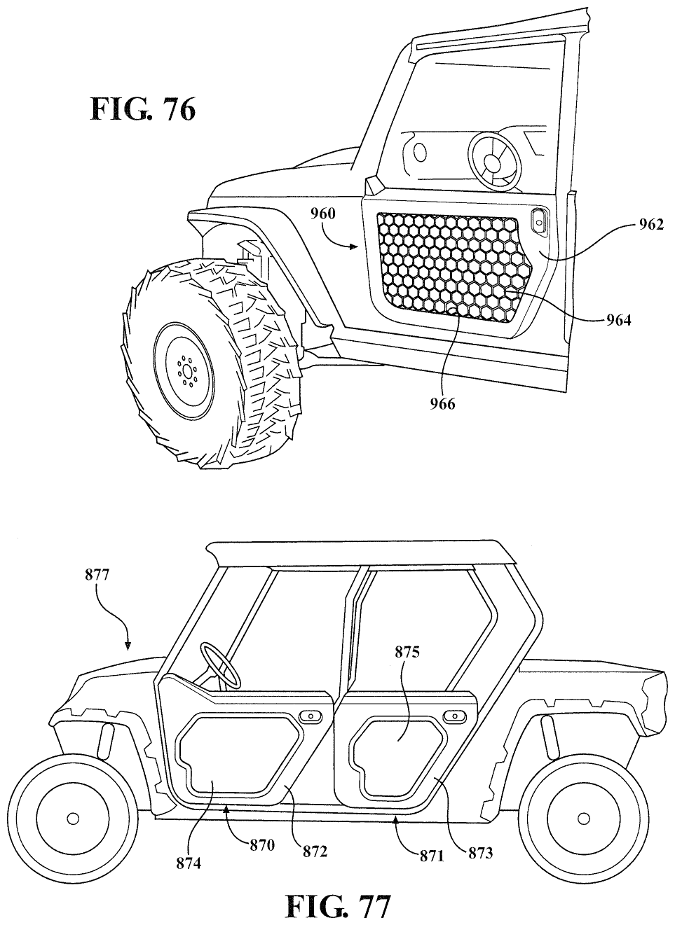

Referring now to FIG. 77, there is depicted side door assembly execution on a power sports/SXS/UTV vehicle platform. A first side door assembly 870 (e.g., front door) includes a door structure 872 operably connected to the vehicle 877 (e.g., hinged) and a door panel 874 connected to the door structure 872. A second side door assembly 871 (e.g., rear door) includes a door structure 871 operably connected to the vehicle 877 (e.g., hinged) and a door panel 875 connected to the door structure 871.

It is understood that right side door assembly is a mirror image to the left side door assembly. It is further understood that the assembly is readily adaptable for a front side door assembly and for a rear side door assembly of the present invention, and that while one may be depicted—this present invention is not limited to either a front door or a rear door. The door panels and side door assembly are adaptable for any modular side door assembly and features, e.g., add-on accessories, accessory attachment methods, core door executions, door structure, steel metal structures, enclosure panels, enclosure panel materials, front side doors (right/left) assemblies, rear side doors (right/left) assemblies, door structure, door panels, removable panels, removable panel schemes, removable panel structures and variations, etc. and in any combinations thereof, depicted or described throughout this application.

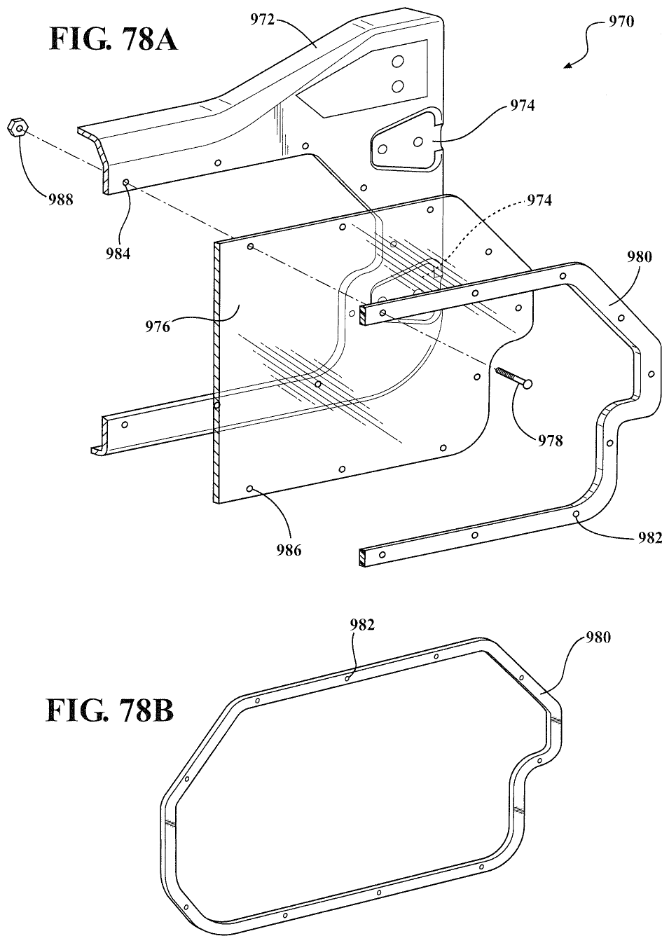

Referring now to FIGS. 78A-78B, there is depicted attachments, in accordance with aspects of the present invention. An exploded view of a side door panel assembly 970 cross section is illustrated. The assembly 970 includes door structure 972 with hinge attachments 974 for connecting to a vehicle. A door panel 976 is operably connected to the door structure 972 with a plurality of fasteners 978. At least one attachment feature 980, e.g., die-cut or formed-in-place gasket, includes a plurality of apertures 982 is located to an outer side of the door panel 976 adjacent outer surface of the door structure 972. The door panel 976 includes a plurality of corresponding apertures 982. The door structure 972 includes a plurality of apertures 984 aligning with the gasket apertures 982 and door panel apertures 986, respectively. The apertures are in alignment and the plurality of fasteners 978 fit through the aligned apertures, respectively. The plurality of fasteners 978 are press-in studs or weld-in studs or bolts or any other suitable fastener, e.g., nut 988 and bolt 978. The attachment feature 980 is preferably a bead lock style “ring” mount that compresses the door panel 976 or “enclosure panel” against the door structure 972.

It is understood that right side door assembly is a mirror image to the left side door assembly. It is further understood that the assembly is readily adaptable for a front side door assembly and for a rear side door assembly of the present invention, and that while one may be depicted—this present invention is not limited to either a front door or a rear door. The door panel (and side door assembly 980) are adaptable for any modular side door assembly and features, e.g., add-on accessories, accessory attachment methods, core door executions, door structure, steel metal structures, enclosure panels, enclosure panel materials, front side doors (right/left) assemblies, rear side doors (right/left) assemblies, door structure, door panels, removable panels, removable panel schemes, removable panel structures and variations, etc. and in any combinations thereof, depicted or described throughout this application.

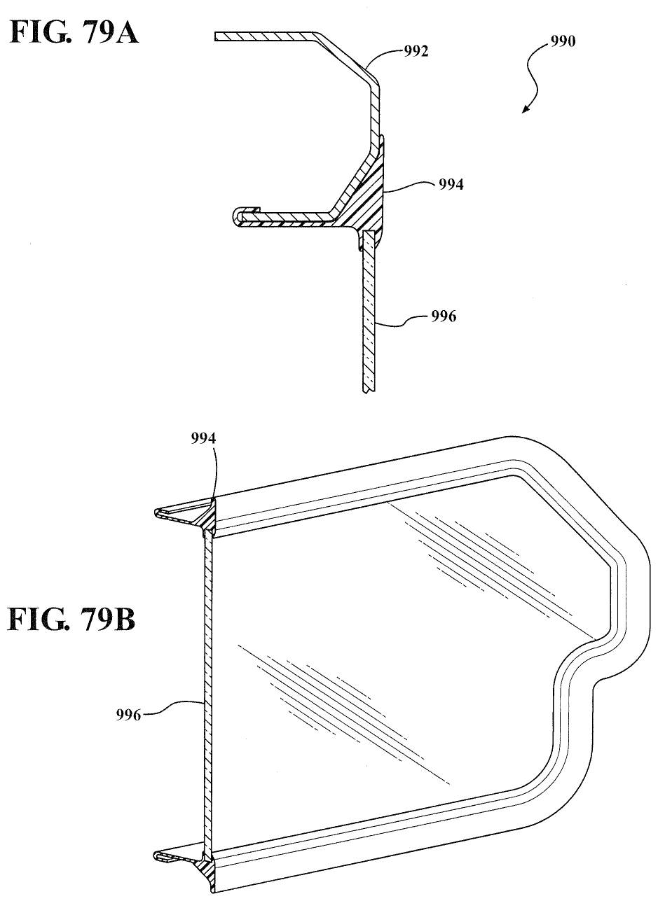

Referring now to FIGS. 79A-79B there is depicted side door assembly 990, in accordance with an aspect of the present invention. FIGS. 79A-79B depict a cross section of the side door assembly 990 including a door structure 992 with hinge points for attachment to a vehicle. A door panel 996 is operably connected to the door structure 992 by at least one attachment member 994. The attachment member 994 is operably connected to the door panel 996 pane. The door structure 912 includes at least one J-rail to receive the attachment member 994 to thereby connected connect the door panel 996 to the door structure 992. Preferably, the door structure 992 is a door casting or structure. The attachment member 994 is preferably rubber or other elastic material. The assembly includes molded form mechanically attached via tension over center. The door panel 996 is preferably overmolded. The assembly 990 creates a weather tight seal and an attachment via molder.

It is understood that right side door assembly is a mirror image to the left side door assembly. It is further understood that the assembly is readily adaptable for a front side door assembly and for a rear side door assembly of the present invention, and that while one may be depicted—this present invention is not limited to either a front door or a rear door. The door panel (and side door assembly 990) are adaptable for any modular side door assembly and features, e.g., add-on accessories, accessory attachment methods, core door executions, door structure, steel metal structures, enclosure panels, enclosure panel materials, front side doors (right/left) assemblies, rear side doors (right/left) assemblies, door structure, door panels, removable panels, removable panel schemes, removable panel structures and variations, etc. and in any combinations thereof, depicted or described throughout this application.

Referring generally to FIGS. 1-79B, in accordance with any of the aspects of the present invention, depicted in the figures or described, each door assembly is adaptable to be metal, preferably steel metal that is one or more of the following, and any combinations thereof: laser cut, broke edges/welded ACE door; laser cut, press brake; laser cut panel/formed top; laser cut, panel perimeter cuts, bent welded to provide recess; formed/stamped inner/outer (trad door). In accordance with any of the aforementioned aspects of the present invention, each door assembly is adaptable to have at least one panel attachment that is one or more of the following, and any combinations thereof: formed lip with stamping operation; bead rolled edge; welded on ring; bolted on ring. In accordance with any of the aforementioned aspects of the present invention, each door assembly is adaptable to be fiberglass, preferably a fiberglass layup. In accordance with any of the aforementioned aspects of the present invention, each door assembly is adaptable to be fiberglass, preferably a fiberglass layup. In accordance with any of the aforementioned aspects of the present invention, each door assembly is adaptable to be thermoformed, preferably a thermoformed panel/tube structure, most preferably, incorporating at least one press on clamps (kick plates), nut bolts and combinations thereof. In accordance with any of the aforementioned aspects of the present invention, each door assembly is adaptable to be thermoformed, preferably a thermoformed panel/stamped structure. In accordance with any of the aforementioned aspects of the present invention, each door assembly is adaptable to be injection molded. In accordance with any of the aforementioned aspects of the present invention, each door assembly is adaptable to be rotational molded. In accordance with any of the aforementioned aspects of the present invention, each door assembly is adaptable to include a plurality of removable panels, which are the same or different from one another. In accordance with any of the aforementioned aspects of the present invention, each door assembly is adaptable to include a wireframe door with at least one removable panel (e.g., fabric and panel in one). In accordance with any of the aforementioned aspects of the present invention, each door assembly is adaptable to include at least one enclosure panel, preferably, a plurality of enclosure panels, which are the same or different from one another. In accordance with any of the aforementioned aspects of the present invention, each door assembly is adaptable to include at least one enclosure panel of at least one material that is a poly carbonate panel, tempered glass panel, tempered glass panel (combo w/ poly carb), vented/sliding window panel (window from upper slider door), metal mesh, carbon fiber, plastic panel (e.g., rotational molded/blow molded, thermoformed, flat piece, extruded section, etc), hat section (e.g., provide inner storage and original crawler look), molded panel, or any other suitable material and combinations thereof. In accordance with any of the aforementioned aspects of the present invention, each door assembly is adaptable to include enclosure panel placement that is inner mounted (e.g., flush to outer surface, inset, etc), outer mounted (e.g., flush to outer surface, sitting on outer surface (proud), boxy bump out, “J” rail on rear doors for dusters, etc), hydro formed, recessed (e.g., inner and outer mounted), glove over whole door, or any other suitable panel placement(s) and combinations thereof. In accordance with any of the aforementioned aspects of the present invention, each door assembly is adaptable to include enclosure panel attachment/hardware schemes including the following: C clamp/clip style (e.g., giant TG bar clip); giant C channel (e.g., C channel slid when door open); slide in track (e.g., TT pro rear window but 1 side open); trad nut/bolt; Dzus fastener/¼ turn fastener; snap buttons; hang hook tension post; one way studs; hook and loop/wing nut/stud; toggles on panel/on door; soft H-channel/windshield weather strip, placed in lower channel, press in top (e.g., plastic clips, spring clamp, etc), grommet, soft web, press in top, and any other suitable enclosure panel attachment/hardware and combinations thereof. In accordance with any of the aforementioned aspects of the present invention, each door assembly is adaptable to include add on accessories, e.g., soft mesh, soft webbing, soft bags, hard sided bags (hard pannier), semi-rigid 3D formed sided bags (soft pannier), backpack, and any other suitable add-on accessory and any combinations thereof. In accordance with any of the aforementioned aspects of the present invention, each door assembly is adaptable to include add-on accessories attachment method that is panel attachment soft such as hard/semi rigid halo (e.g., clicker cut plastic, injection molded plastic, sheet metal halo (laser/stamped), wire (foldable Frisbee/dog bowl), thicker rod (2-pc door), fiberglass tent pole, bonded on, sewn on, and any other suitable attachment and any combinations thereof; hook and loop; elastic loops (e.g., over current toggles), sew in P&C/carrier mounted to, and any other suitable panel attachment and any combinations thereof. In accordance with any of the aforementioned aspects of the present invention, each door assembly is adaptable to include any of the following: powered steps (e.g., to roof access), fixed step, lower doors with roll up windows, wiring harness and switches for T.T. Pro (e.g., Jeep without hardtops), power mirrors and switches, illumination lighting effect, prismatic lens panel, electro magnet powered by vehicle as driving, and any combinations thereof.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A side door assembly, comprising:
at least one door structure;
at least one opening in said at least one door structure; and
at least one accessory selectively attached to said door structure by a at least one attachment interface to selectively attach the at least one door panel to said door structure.

2. The side door assembly of claim 1, wherein said at least one accessory is at least one door panel.

3. The side door assembly of claim 2, further comprising a plurality of rotary attachment features selectively connecting said at least one door panel to said at least one door structure, wherein said rotary attachment features are toggle switches.

4. The side door assembly of claim 2, further comprising a plurality of rotary attachment features provided on said door structure and selectively connecting said at least one door panel to said at least one door structure.

5. The side door assembly of claim 1, further comprising a plurality of structural reinforcements extending from around said opening of said door structure to add strength to said door structure.

6. The side door assembly of claim 5, wherein said plurality of structural reinforcements are ribs.

7. The side door assembly of claim 1, further comprising at least one gasket operable for connecting the door panel to the at least one accessory with a plurality of fasteners.

8. The side door assembly of claim 1, wherein said door is a half door.

9. The side door assembly of claim 1, wherein said door is a full door.

10. The side door assembly of claim 1, wherein said door structure is steel with a fiberglass layup.

11. The side door assembly of claim 1, wherein said door structure incorporates a thermoformed panel over a metal tube structure.

12. The side door assembly of claim 1, wherein the side door assembly further comprises at least one enclosure panel.

13. The side door assembly of claim 12, wherein the at least one enclosure panel material is selected from the group consisting of polycarbonate panel, tempered glass panel, vented window panel, sliding window panel, vented pivoting window panel, metal mesh, carbon fiber, plastic panel, netting, webbing, soft mesh, canvas, fabric and any combinations thereof.

14. The side door assembly of claim 12, wherein the at least one enclosure panel is a plastic panel selected from the group consisting of rotational molded, blow molded, thermoformed, a flat piece or extruded section and any combination thereof.

15. The side door assembly of claim 1, wherein the at least one door panel is transparent.

16. The side door assembly of claim 1, wherein the at least one door panel includes at least one bump-out to a class “A” surface for attachment to an interior surface of the door structure or door panel of at least one accessory.

17. The side door assembly of claim 1, further comprising at least one add-on accessory selected from the group consisting of soft mesh, soft webbing, soft bags, hard sided bags, backpack, map pocket and any combinations thereof.

18. The side door assembly of claim 13, wherein at least one attachment system for attachment of said at least one add-on accessory includes a hard or semi-rigid halo operably connected to the at least one accessory.

19. A side door assembly, comprising:
at least one door structure;
at least one opening in said at least one door structure; and
at least one accessory selectively attached to said door structure by a at least one attachment interface to selectively attach the at least one door panel to said door structure,
wherein the at least one accessory includes an enclosure operably panel attached to the at least one door structure by an attachment system selected from the group consisting of clamp/clip, c-channel, slide in track, nut/bolt, a plurality of fasteners, hook and loop, wing nut/bold, toggles on the door panel or door structure, soft H-channel/weather strip, and any combinations thereof.

20. A side door assembly, comprising:
at least one door structure;
at least one opening in said at least one door structure; and
at least one accessory selectively attached to said door structure by a at least one attachment interface to selectively attach the at least one door panel to said door structure,
wherein the at least one accessory includes an enclosure that is operably inner mounted flush with respect to an outer surface of the at least one door structure, inset mounted with respect to an outer surface of the at least one door structure, or outer mounted.
